(19) United States
(12) Patent Application Publication
(10) Pub. No.: US 2010/0170796 A1
(43) Pub. Date: Jul. 8, 2010

(54) In Vitro Microfluidic Model of Microcirculatory Diseases, and Methods of Use Thereof

(75) Inventors: Sangeeta N. Bhatia, Lexington, MA (US); David T. Eddington, Wheaton, IL (US); John M. Higgins, Cambridge, MA (US); Lakshminarayanan Mahadevan, Brookline, MA (US)

Correspondence Address: FOLEY HOAG, LLP;PATENT GROUP, WORLD TRADE CENTER WEST, 155 SEAPORT BLVD, BOSTON, MA, 02110, US

(73) Assignees: MASSACHUSETTS INSTITUTE OF TECHNOLOGY, CAMBRIDGE, MA (US); PRESIDENT AND FELLOWS OF HARVARD COLLEGE OFFICE OF, CAMBRIDGE, MA (US)

(21) Appl. No.: 12/525,752

(22) PCT Filed: Feb. 8, 2008
(86) PCT No.: PCT/US08/53442

§ 371 Date: Mar. 15, 2010

Related U.S. Application Data
(60) Provisional application No. 60/900,242, filed on Feb. 8, 2007.

(51) Int. Cl. G01N 27/26; G01N 27/447

(52) U.S. Cl. 204/453; 204/601

(57) ABSTRACT

One aspect of the invention relates to a microfluidic device which recreates important features of the human microcirculation on a microscope stage. In certain embodiments of the invention, the clinical scenario associated with ‘sickle cell crisis’ whereby blood vessels are occluded in various organs causing pain and tissue damage can be recreated. In certain embodiments, one can use a device of the invention to study the processes that lead to crisis, and screen therapies (such as small molecules) that might be used to prevent crisis. Further, certain embodiments of the invention allow one to study and screen therapies for a range of human blood disorders, such as hereditary spherocytosis, disorders of white blood cells, such as Waldenstrom's macroglobulinemia or leukocytosis, disorders of blood platelets and coagulation, such as hemophilia A and B, activated protein C resistance, and essential thrombocythemia.

### RELATED APPLICATIONS

This application claims the benefit of priority to United States Provisional Patent Application Ser. No. 60/900,242, filed Feb. 8, 2007; the entirety of which is hereby incorporated by reference.

### GOVERNMENT SUPPORT

This invention was made with support provided by the National Institutes of Health (Grant No. F32DK072601-01); therefore, the government has certain rights in the invention.

### BACKGROUND OF THE INVENTION

There are very few existing microfluidic models of disorders of blood flow. In particular, there are very few, if any, in vitro models of sickle cell crisis or vaso-occlusion (blockage of blood vessels). While several patents discuss sickle cell disease and microfluidic devices (such as U.S. Pat. Nos. 7,015,030; 6,960,437; 6,613,525; 6,344,326; 6,326,211; 6,074,827; and 6,007,690; all of which are incorporated by reference), none of these patents discloses a method for studying sickle cell disease or blood disorders in general. Instead, these patents focus on the use of microfluidic devices for specimen sampling and processing for the purposes of identifying individuals with disease and do not claim to recapitulate dynamic physiologic properties for disease monitoring or other purposes. In addition, while there are a few patents which relate to microfluidic chips and blood flow (such as U.S. Pat. Nos. 6,868,347; and 6,592,519; all of which are incorporated by reference), these patents relate to methods for studying non-ideal fluids in microfluidic devices using optical tomography and implantable devices without clinical implications.

In addition to the patents listed above, there have been several efforts to evaluate individual components of red blood cell behavior in isolated states. Ballas S K, Mohandas N “Sickle red cell microrheology and sickle blood rheology.” Microcirculation 2004, 11(2), 209-25. However, none of these efforts attempts to recapitulate simultaneously the microcirculatory geometries, flow rates, blood composition, and gas concentrations. Further, there have been several uses of microfluidic devices to separate and manipulate blood for analysis, yet none of these approaches simulates full physiologic or pathologic processes. Toner M, Irimia D “Blood-on-a-chip.” Annual Review of Biomedical Engineering 2005 7, 77-103; Price A K, Martin R S, Spence D M “Monitoring erythrocytes in a microchip channel that narrows uniformly: Towards an improved microfluidic-based mimic of the microcirculation.” Journal of Chromatography A 2006, 1111(2), 220-7.

Given the limitations of the devices and methods known in the art, there exists a need for a device and method which would allow one to vary independently individual parameters (blood specimen composition, oxygen, vessel geometry) in an integrated system. While it is true that certain in vitro systems offer simple control over a single variable, such as oxygen tension, this control cannot be coupled with other flow variables nor with interaction with other cells. Further, there exists a need for a device which allows measurement or readouts to be made continuously at arbitrary points in space and by leveraging a range of existing imaging modalities (light and fluorescent microscopy). The invention disclosed herein provides such devices and methods.

### SUMMARY OF THE INVENTION

One aspect of the invention relates to a microfluidic device which recreates important features of the human microcirculation on a microscope stage. Such a device enables one to control precisely parameters known to be important in human diseases (e.g., oxygen concentration in sickle cell anemia, channel geometry in malaria, flow rate, pressure, adhesion to the vessel wall) and thus enables real-time visualization of events that normally occur in the smallest vascular beds of the body. Conventional wisdom suggests that one needs living blood vessels lined with endothelial cells in order to recreate processes, such as adhesion, rolling, and clotting; thus, the classical approach to this problem is to implant glass ‘windows’ in animals where flow can be visualized microscopically. However, an in vivo approach does not allow one to vary systematically parameters of interest (channel dimensions, oxygen concentrations), is inherently low throughput, and is not an appropriate model for human diseases for which rodent models either do not exist or are inadequate (e.g., malaria, sickle cell).

In certain embodiments of the invention, the clinical scenario associated with ‘sickle cell crisis’, whereby blood vessels are occluded in various organs causing pain and tissue damage, can be recreated. As mentioned above, this had not been previously achieved ex vivo (outside the body), in part, because it was widely believed that adhesion to a living vessel wall is an important component of this process, mandating study of this process in vivo. In contrast, as disclosed herein, control of the oxygen environment of blood flowing through a completely synthetic microfluidic network (with no endothelial lining) is sufficient to cause ‘sickling’ of red blood cells from sickle cell patients and completely block flow; this situation is in some sense a ‘stroke on a chip.’

In certain embodiments, one can use a device of the invention to study the processes that lead to crisis, and importantly screen therapies (such as small molecules) that might be used to prevent crisis. In particular, one aspect of the invention relates to methods for investigating the effects of small molecule inhibitors of crisis in the inventive device. In certain embodiments, the device may be useful in individualizing existing treatment for patients.

Further, in certain embodiments, by the addition of known adhesion molecules or endothelial cells, for example, the methods and devices of the invention can be used to analyze and model other blood flow (hemato-rheologic) disorders involving hyperviscosity and thrombosis. Therefore, certain embodiments of the invention may allow one to study and screen therapies for a range of human blood disorders such as hereditary spherocytosis, disorders of white blood cells such as Waldenstrom's macroglobulinemia or leukocytosis, disorders of blood platelets and coagulation such as hemophilia A and B, activated protein C resistance, and essential thrombocythemia

Remarkably, because the devices of the invention are fabricated using standard microfabrication techniques, the invention provides a platform for parallel, miniaturized, automated assays which can both minimize the cost of reagents and increase the experimental throughput.

### BRIEF DESCRIPTION OF THE FIGURES

FIG. 1 depicts a multi-scale schematic of the collective processes of vaso-occlusion: polymerization of hemoglobin S occurring at the 10-nm length scale, cell sickling at the 10-μm length scale, and vessel jamming at up to 100-μm. The time scales for the different processes range from a fraction of a second for polymerization to a few minutes before a vaso-occlusive event (e.g., jamming of the artificial vessel by deformed and rigid red blood cells).

FIG. 2 depicts a schematic of a representative device of the invention. The oxygen channels and vascular network were fabricated in separate steps. After removal from the SU8 mold master, holes were cored and networks were bonded via oxygen plasma activation and then attached to a glass slide. The widest cross section on the left and right of the device is 4-mm×12-μm. The network then bifurcates, maintaining a roughly equal cross-sectional area. An open 5 mL syringe was connected to the device and raised and lowered to increase or decrease the flow rates through the device. The gas channels were connected to two rotometers which regulated the ratio of 0% and 10% oxygen in the gas mixture which was fed into the device. The outlet of the gas network had an oxygen sensor to validate the oxygen concentration in the microchannels.

FIG. 3 depicts schematic top-views of two embodiments of a device of the invention. Fluidic channels are shown in black and gas channels are shown as grey. The gas and fluidic channels are separated by a thin membrane, which oxygenates or deoxygenates the channels accordingly. In [A] an schematic of a device is shown with 5 bifurcations. In [B] an schematic of a device is shown wherein each fluidic channel is exposed to successive gas concentrations (high and low oxygen) as blood travels along the fluidic channels.

FIG. 4 depicts [A] an image of the bifurcated microfluidic channels, scale bar is 125 μm; and [B] an image of abnormal hemoglobin (HbS) blood in microchannels, scale bar is 50 μm.

FIG. 5 depicts a phase space of vaso-occlusion. The red isosurface represents a fitted hypersurface in (width, pressure, oxygen, occlusion time) space. The isosurface was computed from 43 data points using Delaunay triangulation (See the MATLAB griddata3 function documentation.) All points on the hypersurface correspond to (width, pressure, oxygen) triples where the fitted time to occlusion was 500 seconds. As a measure of the goodness of the isosurface fit, residuals were calculated for all 23 data points located in the interior of the volume. The mean residual for all 23 points was 46% of the actual time to occlusion, with a variance of 26. 20 of these points had residuals <67%, and 13 of these points had residuals <33%. The filled contour plots represent slices through the fitted volume at the planes (top: oxygen concentration=0.5%, middle: normalized pressure=20, bottom: minimal dimension=25 μm). This phase space describes the behavior of patient samples containing hemoglobin S concentrations of at least 65% (mean 86%, standard deviation 6.7%). Pressures were normalized for hematocrit and for the individual device used. Normalized pressure represents the pressure estimated to drive a sample of 25% hematocrit through the specific device at a given velocity prior to any crisis/rescue cycles. It was found that the stochasticity in the vaso-occlusive event leads to large variations about the mean time for jamming. The deviations from the mean time to occlusion were characterized by

$$X = \frac{1}{n} \sum \frac{\vert {t}_{fit} - {t}_{actual} \vert}{{t}_{actual}} ;$$

it was found that X is 46%; i.e., vaso-occlusion is highly heterogeneous temporally.

FIG. 6a depicts velocity profiles for an occlusion and relaxation assay for a device with a minimal width of 30 μm and a blood sample with 92% hemoglobin S. Data points represent measured velocities normalized to the maximum within each assay. Lines represent least-squares exponential fits. The least squares exponential fit of the occlusion measurements had a time scale of about 124 seconds, while the corresponding time scale fit to the relaxation profile was about 22 seconds. It was noted that the velocity of the red blood cells actually does vanish on occlusion. The inset shows the oxygen concentration profiles as measured during a control experiment detailed in the Exemplification. The velocity profile measurements begin with measurable changes in velocity which occurs when intracellular oxygen concentration drops below 3% or rises above 1%.

FIG. 6b depicts ratios of characteristic occlusion and relaxation times for occlusion and relaxation assays in devices with different minimal widths. The circles represent individual data points (5 at 7 μm, 9 at 15 μm, and 8 at 30 μm). The horizontal bars represent sample means. The rectangles represent the extent of the mean+/−the sample standard deviation.

FIG. 7 depicts velocity profiles for occlusion of a patient blood sample before and after therapeutic red blood cell exchange as measured in a device with a minimal width of 30 μm and ambient oxygen concentration that is suddenly reduced to 0%. Velocities are normalized to the maximum within each assay. The cross data points represent the behavior of the patient's sample prior to treatment (78% hemoglobin S). The circle data points represent behavior of a sample obtained following treatment (31% hemoglobin S). The lines represent least-squares exponential fits. Note that the velocity of the treated specimen vanishes after a finite time, while that of the treated specimen never vanishes. The inset shows oxygen concentration profiles as measured during a control experiment detailed in the Exemplification.

FIG. 8 depicts velocity profiles for occlusion with and without carbon monoxide. All assays were carried out in a device with a minimal width of 15 μm and a patient blood sample with 85.5% hemoglobin S. The circle, square and triangle markers correspond to three different occlusion assays with no oxygen or carbon monoxide. The star and cross correspond to assays with 0.01% carbon monoxide and 0% oxygen. The inset shows the gas concentration profiles, with the bottom inset reflecting control measurements detailed in the Exemplification.

FIG. 9 depicts oxygen concentration profiles after gas mixture change. A ruthenium-coated microscope slide was attached to the bottom of the microfluidic device. A x indicates measurements underneath the gas inlet (near the blood outlet) of the device; an o, measurements underneath the gas outlet (near the blood inlet) of the device; red markers, measurements made after increasing oxygen from 0% to 10% at time 0; blue markers, measurements made after decreasing the oxygen from 10% to 0% at time 0. These concentration profiles represent upper bounds (o) and lower bounds (x) on the concentrations in the fluid channels where data were collected because they represent concentrations at positions farther up and down the gas stream. Thresholds for the onset of significant polymerization and melting are about 3% and about 1%.

FIG. 10 depicts velocity profiles for control specimens at 0% oxygen. Experiments were carried out in devices with minimal width of 15 μm. It was observed that there was no occlusion in normal blood (no HbS) or in blood from a patient with the heterozygous form, i.e., sickle trait (33% HbS).

FIG. 11 depicts velocity profiles for occlusion with and without addition of phenylalanine or pyridoxal (3-hydroxy-5-(hydroxymethyl)-2-methyl-4-pyridinecarboxaldehyde; a DPG analog). Experiments were conducted in a device with a minimal width of 30 μm and a blood sample with hemoglobin S concentration of 85.5%. There was little observable change in the dynamics of occlusion due to the presence of these small-molecule drugs.

FIG. 12 depicts a simplified qualitative model of vaso-occlusion. As oxygen concentration falls, the concentration of sickled red blood cells increases. This increasing concentration provides greater resistance to flow and eventually leads to vaso-occlusion.

FIG. 13 depicts distributions of instantaneous acceleration measurements during the onset of occlusion (Upper) and rescue (Lower). Accelerations were measured by computing mean field velocities for consecutive frames in 3-sec videos captured at 60 frames per second. Videos with linear fits to measured velocity profiles with slopes statistically different from zero were included in the analysis. The horizontal red bars show the variance of the acceleration distribution. The black tails on the red bars show the extent of the upper and lower bounds of the 95% confidence interval for the true population variance, assuming that the underlying population variance has a χ² distribution.

FIG. 14 depicts shows a sample tracking image (top panel; cells are segmented using morphologic criteria and are tracked from frame to frame using heuristic approaches; a subset of tracked cells bounded by rectangles (bottom panel; the black arrows represent that particular cell's velocity fluctuation amplified by four).

FIG. 15 depicts average fluctuations in squared cellular displacement as a function of time (top); the nature of the collective microscopic dynamics by comparing slopes of graphs like that in the top row with bulk flow velocity (middle; a slope of 1.0 corresponds to diffusive dynamics; and diffusion constants versus bulk velocity for diffusive flows (bottom; the typical diffusion constant is 8 μm²/s with a standard deviation of 5.5 μm²/s). Error bars represent estimates of the binned mean plus and minus the estimated standard deviation.

FIG. 16 depicts microscopic dynamics of oxygenated (top graph) and deoxygenated (bottom graph) sickle cell blood versus bulk velocity with a log-log scale. These plots compare the root mean squared fluctuation velocity to the bulk velocity. Solid lines are linear least squares fits with dotted lines showing the 95% confidence interval for these fits. The legend reports the slope and correlation coefficient for each of these fits; the lines correspond to the listing in the legend, top to bottom. Both types of cells trend toward a slope of 0.50, corresponding to a scaling of [δVᵣₘₛ(t)]²˜V_{bulk} as t becomes sufficiently large.

FIG. 17 depicts a probability distribution function of more than 10,000 normalized squared velocity fluctuations compared with a Maxwell-Boltzmann distribution in two dimensions (chi-squared distributions with two degrees of freedom). Cellular velocity fluctuations are temperature-like.

### DETAILED DESCRIPTION OF THE INVENTION

Provided are microfluidic devices comprising a plurality of interconnected channels. In certain embodiments, the microfluidic devices further comprise a gas reservoir. In such embodiments, the plurality of interconnected channels and the gas reservoir are positioned to allow gas diffusion from the gas reservoir to the plurality of interconnected channels. In certain embodiments, this diffusion is mediated by a gas-permeable membrane.

Methods utilizing devices of the foregoing design are also provided herein. Such methods generally involve providing a microfluidic device such as described above and introducing a sample into the microfluidic networks of bifurcated channels. The inventive devices can be used in a variety of applications, including recreating important features of the human microcirculation on a microscope stage, as well as related clinical assay applications. In further describing the invention, the devices will first be described in general terms followed by a discussion of a representative embodiment which relates to sickle cell disease.

In certain embodiments, the inventive devices are integrated microfluidic devices. By integrated it is meant that all the components of the device, e.g. the plurality of interconnected channels, the gas reservoir and the gas-permeable membrane, etc., are present in a single, compact, readily handled unit, such as chip, disk or the like. The microfluidic device may be constructed in a variety of shapes and sizes so as to allow easy manipulation of the substrate and compatibility with a variety of standard lab equipment such as microtiter plates, multichannel pipettors, microscopes, inkjet-type array spotters, photolithographic array synthesis equipment, array scanners or readers, fluorescence detectors, infra-red (IR) detectors, mass spectrometers, thermocyclers, high throughput machinery, robotics, etc. For example, the fluidic device may be constructed so as to have any convenient shape such as a square prism, a rectangular prism, a cylinder, a sphere, a disc, a slide, a chip, a film, a plate, a pad, a tube, a strand, a box, etc. In certain embodiments, the fluidic device is substantially flat with optional raised, depressed or indented regions to allow ease of manipulation. (See, for example, U.S. Pat. No. 6,776,965; hereby incorporated by referenced in its entirety.)

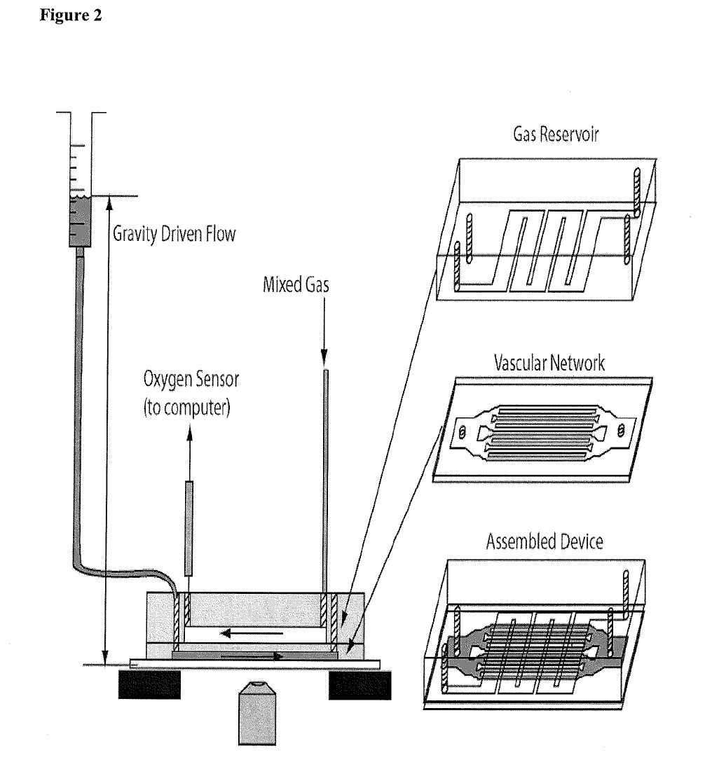

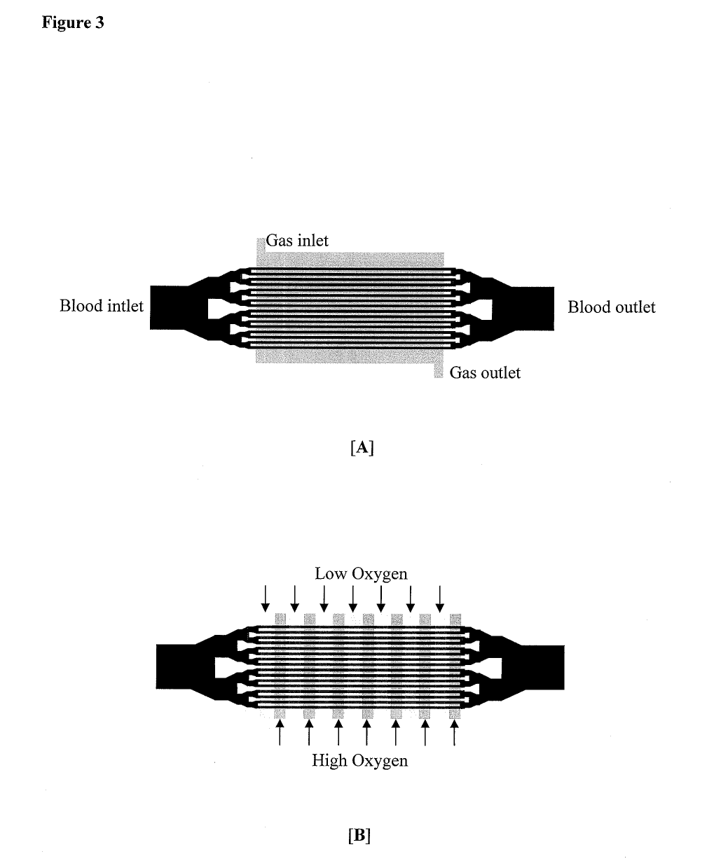

In certain embodiments, the subject device comprises a plurality of interconnected channels, wherein said plurality of interconnected channels comprises at least one sample inlet and at least one sample outlet. In certain embodiments, said plurality of interconnected channels derives from a single channel which is bifurcated one or multiple times (for example, those shown in FIGS. 2 and 3). In certain embodiments, the cross sectional area of the bifurcated channels are kept approximately equal at each bifurcation to ensure an equal velocity along the microfluidic network. For example, in one embodiment, the channels split as follows: 1-4000 μm channel, 2-2000 μm channels, 4-1000 μm channels, 8-500 μm channels, 16-250 μm channels, 32-125 μm channels, 64-63 μm channels, 128-30 μm channels, 256-15 μm channels. In certain embodiments, the bifurcating channels recombine in the same manner in which they split to form one channel which terminates at the sample outlet. In other examples, the arrangement and size of the channels is more tortuous and disordered.

The plurality of interconnected channels may be present in the device in a variety of configurations, depending on the particular use. As used herein, a “channel” refers to a flow path through which a solution can flow. In certain embodiments, the configuration of the channels is tube-like, trench-like or another convenient configuration. The cross-sectional shape of such channels may be circular, ellipsoid, rectangular, trapezoidal, square, or other convenient configuration. In certain embodiments, the channels may have cross-sectional areas which provide for fluid flow through the channels, where at least one of the cross-sectional dimensions, e.g., width, height, diameter, will be at least about 1 μm, usually at least about 10 μm, and will usually not exceed about 8000 μm. Depending on the particular nature of the device, the plurality of interconnected channels may be straight, curved or another convenient configuration on the surface of the planar substrate.

Depending on the configuration of the device, the sample can be caused to flow through the plurality of interconnected channels by any of a number of different means, and combinations of means. In certain embodiments, transport of fluid through the device can occur via capillary forces. Fluid also can be transported through the device system via pressure forces as applied e.g. externally, which force fluid through the device system, or other forces such as centrifugal, gravitational, electrical, osmotic, electro-osmotic and others. Such flow propulsion can be applied individually or in various combinations with each other. In other words, in some device configurations it may be sufficient to allow the sample to flow through the device as a result of gravity forces on the sample, while in others, active pumping means may be employed to move sample through the device.

In certain embodiments the interior surface of the channels can be altered in such a way to effect the fluid flow through the channel. For example, in certain embodiments, known adhesion molecules or endothelial cells can be affixed to the interior surface of the channels. Such modifications would be particularly useful in studying a variety of blood flow (hemato-rheologic) disorders, including hyperviscosity and thrombosis.

The subject device may also optionally comprise an interface means for assisting in the introduction of sample into the plurality of interconnected channels. For example, where the sample is to be introduced by syringe into the device, the device may comprise a syringe interface which serves as a guide for the syringe needle into the device, as a seal, and the like.

In certain embodiments, the plurality of interconnected channels is separated from the gas reservoir by a thin membrane. In certain embodiments, suitable membranes include silicone rubber (e.g. dimethylsilicon rubber), polydimethylsiloxane (PDMS), polytetrafluorethylene (PTFE; Teflon), polypropylene, polysulfone, dimethyl and methyvinyl siloxane copolymers both unsupported and supported on polyester, or like fibers. For example, the Silon™ membrane (siliconed dacron) manufactured by Bio Med Sciences, Inc. of Pennsylvania, or the Silastic™ membrane (silicone membrane) manufactured by Dow Corning of Midland, Mich. In certain embodiments, the membrane is a polydimethylsiloxane (PDMS) membrane.

In certain embodiments, the membrane is highly permeable to oxygen, carbon dioxide, and nitrogen. In such embodiments, diffusion across the membrane oxygenates, deoxygenates, or otherwise modulates the conditions in the fluidic channels accordingly. As would be expected the membrane thickness can control the rate of change in gas concentration in the plurality of interconnected channels. In certain embodiments, the thickness of said membrane is within the range of about 50 μm to about 250 μm. In certain embodiments, the thickness of said membrane is about 150 μm. In certain embodiments, the gas concentration in the plurality of interconnected channels is controlled by the composition of the gas in the gas reservoir. In certain embodiments, the thickness of said gas reservoir is within the range of about 50 μm to about 250 μm. In certain embodiments, the thickness of said gas reservoir is about 150 μm.

Another optional component that may be present in the subject devices is a waste fluid reservoir for receiving and storing the sample volume from the plurality of interconnected channels, where the waste reservoir will be in fluid communication with the sample outlet. The waste reservoir may be present in the device as a channel, compartment, or other convenient configuration which does not interfere with the other components of the device.

In certain embodiments, depending on the particular configuration and the nature of the materials from which the device is fabricated, at least in association with the plurality of interconnected channels will be a detection region for detecting the presence of a particular species in the sample. At least one region of the plurality of interconnected channels in the detection region will be fabricated from a material that is optically transparent, generally allowing light of wavelengths ranging from 180 to 1500 nm, usually 220 to 800 nm, more usually 250 to 800 nm, to have low transmission losses. Suitable materials include fused silica, plastics, quartz glass, and the like.

As mentioned above, the integrated device may have any convenient configuration capable of comprising the plurality of interconnected channels and gas reservoir, as well as any additional components. Because the devices are microfluidic devices, the plurality of interconnected channels will be present on the surface of a planar substrate, where the substrate will usually, though not necessarily, be covered with a planar cover plate to seal the microchannels present on the surface from the environment. In certain embodiments, the devices will be small, having a longest dimension in the surface plane of no more than about 40 mm, usually no more than about 20 mm so that the devices are readily handled and manipulated. As discussed above, the devices may have a variety of configurations, including parallelepiped, e.g., credit card or chip like, disk like, syringe like or any other compact, convenient configuration.

Some of the microfluidic devices described herein are fabricated from a silicon-containing organic polymer. However, the present microfluidic systems are not limited to this one formulation, type or even this family of polymer; rather, nearly any elastomeric polymer is suitable. Given the tremendous diversity of polymer chemistries, precursors, synthetic methods, reaction conditions, and potential additives, there are a large number of possible elastomer systems that can be used. The choice of materials typically depends upon the particular material properties (e.g., solvent resistance, stiffness, gas permeability, and/or temperature stability) required for the application being conducted. Additional details regarding the type of elastomeric materials that may be used in the manufacture of the components of the microfluidic devices disclosed herein are set forth in U.S. application Ser. No. 09/605,520, and PCT Application WO 00/017740, both of which are incorporated herein by reference in their entirety.

In certain embodiments, the microfluidic devices disclosed herein may be constructed, at least in part, from elastomeric materials, and constructed by single and multilayer soft lithography (MLSL) techniques and/or sacrificial-layer encapsulation methods (see, e.g., Unger et al. Science 2000, 288, 113-116, and PCT Application WO 01/01025, both of which are incorporated by reference herein in their entirety).

In addition, in certain embodiments, the subject devices may also be fabricated from a wide variety of materials, including glass, fused silica, acrylics, thermoplastics, and the like. The various components of the integrated device may be fabricated from the same or different materials, depending on the particular use of the device, the economic concerns, solvent compatibility, optical clarity, color, mechanical strength, and the like. For example, both a planar substrate comprising the plurality of interconnected channels and a cover plate may be fabricated from the same material, e.g., poly(dimethylsiloxane) (PDMS), or different materials, e.g., a substrate of PDMS and a cover plate of glass. For applications where it is desired to have a disposable integrated device, due to ease of manufacture and cost of materials, the device will typically be fabricated from a plastic. For ease of detection and fabrication, the entire device may be fabricated from a plastic material that is optically transparent, as that term is defined above. Also of interest in certain applications are plastics having low surface charge under conditions of electrophoresis. Particular plastics finding use include polymethylmethacrylate, polycarbonate, polyethylene terepthalate, polystyrene or styrene copolymers, and the like.

The devices may be fabricated using any convenient means, including conventional molding and casting techniques. For example, with devices prepared from a plastic material, a silicon mold master which is a negative for the channel structure in the planar substrate of the device can be prepared by etching, laser micromachining, or soft lithography techniques. In addition to having a raised ridge which will form the channel in the substrate, the silica mold may have a raised area which will provide for a cavity into the planar substrate for housing of the enrichment channel. Next, a polymer precursor formulation can be thermally cured or photopolymerized between the silica master and support planar plate, such as a glass plate. Where convenient, the procedures described in U.S. Pat. No. 5,110,514, the disclosure of which is herein incorporated by reference, may be employed. After the planar substrate has been fabricated, the enrichment channel may be placed into the cavity in the planar substrate and electrodes introduced where desired. Finally, a cover plate may be placed over, and sealed to, the surface of the substrate, thereby forming an integrated device. The cover plate may be sealed to the substrate using any convenient means, including ultrasonic welding, adhesives, etc.

In certain embodiments, prior to using the subject device, water will be introduced into the plurality of interconnected channels of the device prior to the introduction of a sample.

In certain embodiments, the microfluidic channels are filled with whole blood, and flow is driven by gravity. The flow rates are adjusted by varying the height of the gravity feed. In certain embodiments, the blood is first fractionated, and different fractions are examined in the inventive devices. In yet other embodiments, the osmolarity of the blood can be altered, by the addition of a foreign substance such as sucrose or distilled water. All such devices could be used to study diseases of the blood, screen drug candidates for diseases of the blood, to diagnose blood disorders, and as a point-of-care device to functionally characterize blood of individual patients at baseline or in response to some intervention. Such embodiments are discussed in greater detail below.

### An Application to Sickle Cell Disease

One aspect of the invention relates to the occlusive crisis which occurs in patients afflicted with sickle cell disease. The pathophysiology of sickle cell disease is complicated by the multi-scale processes that link the molecular genotype to the organismal phenotypehemoglobin polymerization occurring in milliseconds, microscopic cellular sickling in a few seconds or less (Eaton, W. A. & Hofrichter, J. (1990) Adv Protein Chem 40, 63-279), and macroscopic vessel occlusion over a time scale of minutes, the last of which is necessary for a crisis (Bunn, H. F. (1997) N Engl J Med 337, 762-769). Herein, it is shown that it is possible to evoke, control, and inhibit the collective vaso-occlusive or jamming event in sickle cell disease (for example, by using an artificial microfluidic environment). A combination of geometric, physical, chemical and biological means have been used to quantify the phase space for the onset of a jamming event, as well as its dissolution and find that oxygen-dependent sickle hemoglobin polymerization and melting alone are sufficient to recreate jamming and rescue. It is further disclosed that a key source of the heterogeneity in occlusion arises from the slow collective jamming of a confined, flowing suspension of soft cells that change their morphology and rheology relatively quickly. Finally the effects of small molecule inhibitors of polymerization and therapeutic red blood cell exchange on this dynamical process are quantified. The results disclosed herein, which integrate the dynamics of collective processes associated with occlusion at the molecular, polymer, cellular and multi-cellular (e.g. tissue) level, lay the foundation for a quantitative understanding of the rate limiting processes, and provide a potential tool for individualizing and/or optimizing treatment, as well as provides a test bench for identifying and investigating drugs.

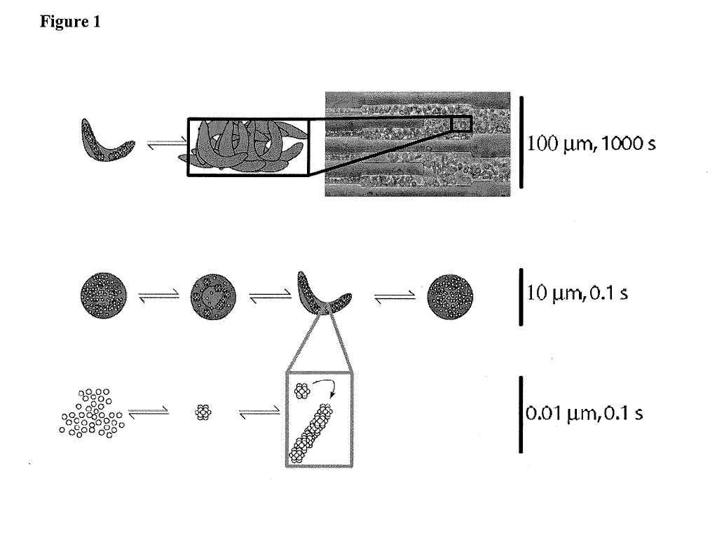

Understanding the pathophysiology of genetic diseases is complicated by the multi-scale collective nature of the physical, chemical and biological processes that link the molecular genotype to the organismal phenotype. Sickle cell disease, the first molecular disease to be identified more than a half century ago has been studied extensively at the molecular, cellular and organismal level. Although much is known individually about the molecular details of sickle hemoglobin polymerization, sickle cell deformability and its effect on flow, and the clinical heterogeneity of sickle cell disease, integrating these processes remains a challenge. Pauling, L., H. A. Itano, et al. (1949). “Sickle cell anemia a molecular disease.” Science 110(2865): 543-8; Eaton, W. A. and J. Hofrichter (1990). “Sickle cell hemoglobin polymerization.” Adv Protein Chem 40: 63-279; Mozzarelli, A., J. Hofrichter, et al. (1987). “Delay time of hemoglobin S polymerization prevents most cells from sickling in vivo.” Science 237(4814): 500-6; Gregersen, M. I., C. A. Bryant, et al. (1967). “Flow Characteristics of Human Erythrocytes through Polycarbonate Sieves.” Science 157(3790): 825-827; Alexy, T., E. Pais, et al. (2006). “Rheologic behavior of sickle and normal red blood cell mixtures in sickle plasma: implications for transfusion therapy.” Transfusion 46(6): 912-8; Bunn, H. F. (1997). “Pathogenesis and treatment of sickle cell disease.” N Engl J Med 337(11): 762-9; and Ballas, S. K. and N. Mohandas (2004). “Sickle red cell microrheology and sickle blood rheology.” Microcirculation 11(2): 209-25. Since it is the collective action at the molecular and cellular level which is medically and scientifically most important, a useful understanding of the sickle cell disease process requires the integration of experiments and models at multiple scales: microscopic hemoglobin polymerization, mesoscopic cellular sickling, and macroscopic vascular occlusion (crisis), shown schematically in FIG. 1. Only by capturing and integrating processes at each level of scale can one hope to find meaningful and effective treatments.

It is well known that at the molecular level the polymerization of hemoglobin S (HbS) occurs via a double-stranded nucleation mechanism and leads to explosive cooperative growth that is critically dependent on the ambient partial pressure of oxygen. Mozzarelli, A., J. Hofrichter, et al. (1987). “Delay time of hemoglobin S polymerization prevents most cells from sickling in vivo.” Science 237(4814): 500-6; and Ferrone, F. A. (2004). “Polymerization and sickle cell disease: a molecular view.” Microcirculation 11(2): 115-28. Polymerization leads to the formation of HbS fibers and thus lowers the oxygen affinity, facilitating the unloading of oxygen into tissue and thus could provide a physiological advantage. However, polymerization of HbS changes the morphology and stiffness of the red blood cell and thus its ability to flow through the narrowest capillaries. Eaton, W. A. and J. Hofrichter (1990). “Sickle cell hemoglobin polymerization.” Adv Protein Chem 40: 63-279; and Cohen, A. E. and L. Mahadevan (2003). “Kinks, rings, and rackets in filamentous structures.” Proc Natl Acad Sci USA 100(21): 12141-6. In vascular tissue consuming oxygen the cells slow down and the local oxygen concentration falls more sharply, leading to further sickling through a positive feedback mechanism, and eventually jamming of the vessel termed vaso-occlusion, shown schematically in FIG. 1a. Polymerization and sickling alone have no severe pathophysiological consequences, whereas the obstruction of microvessels and the consequent oxygen deprivation of tissue lead to significant disease. Indeed this jamming of moving particles in a confined environment which occurs in a number of physical processes such as the flow of grains, colloids, and traffic in confined environments (Liu, A. J. and Nagel, S. eds. (2001) Jamming and Rheology. (Taylor and Francis, London)), where collective effects are crucial in determining the response of the system, is also important in other pathophysiologic processes such as leukostasis in leukaemia (Porcu, P., Cripe, L. D., Ng, E. W., Bhatia, S., Danielson, C. M., Orazi, A., & McCarthy, L. J. (2000) Leuk Lymphoma 39, 1-18) and hyperviscosity syndrome in multiple myeloma (Rampling, M. W. (2003) Semin Thromb Hemost 29, 459-465). In sickle cell disease, the phenomena just described involve two collective processes at different length and timescales: that of sub-second polymerization and morphological and rheological change at the length scale of an individual cell; and that of collective hydrodynamic flow of a soft suspension of cells which form an occlusive plug the size of an entire confining vessel and slow down over the course of minutes. Therefore, the onset of vaso-occlusion is governed by the ratio of two fundamental time scales in the problem (Eaton, W. A. & Hofrichter, J. (1990) Adv Protein Chem 40, 63-279): the polymerization time τₚ for the sickling of a cell in an oxygen-deprived environment, which is directly dependent on the intracellular concentration of HbS, the local oxygen concentration, and any significant intracellular concentrations of other hemoglobin isoforms such as fetal hemoglobin (HbF); and the kinetic time τₖ for blood to transit a narrow long vessel, which is dependent on the pressure gradient driving the flow, the diameter of the vessel, and the effective viscosity of the blood, which depends on the concentration, shape, and elasticity of the cells it contains. If τₚ>τₖ, then the deoxygenated blood cell returns to the lungs before sickling, while if rₚ<Tₖ the propensity for polymerization, sickling, and occlusion increases dramatically (Mozzarelli, A., Hofrichter, J., & Eaton, W. A. (1987) Science 237, 500-506).

The temporal progression of blood flow and occlusion in a vessel are therefore controlled in part by the large scale pressure gradient, vessel diameter, red cell concentration in the blood (hematocrit), intracellular HbS concentration, and oxygen concentration. Remarkably, the microfluidic chip of invention allows one to independently vary the various parameters that control the onset of vaso-occlusion. In other words, one is able to dissect and probe the hierarchical dynamics of this multi-scale process by manipulating the geometrical, physical, chemical and biological determinants of the process and thus parse out the rate limiting processes that govern occlusion and its rescue. Specifically, the aforementioned chip consists of a series of bifurcating channels of varying diameters that grossly mimics the geometry of vasculature as shown in FIG. 2 which enables the independent modulation of these parameters to control the onset of vaso-occlusion and its reversal. For example, by controlling the physical pressure gradient across the chip, one can vary the kinetic time scale for transit of red blood cells. The channels are separated from a gas reservoir by a thin gas-permeable polydimethylsiloxane (PDMS) membrane. As the geometries are microscopic, gas diffusion is rapid and the oxygen concentration in the microchannels is governed by the concentration in the gas reservoir. By changing the mixture in this reservoir, one can control oxygen concentrations in the channels and thence the onset of microscopic hemoglobin polymerization. By using blood with varying concentrations of HbS and different hematocrits, one can mimic the variability among individuals.

Since vaso-occlusion fundamentally represents the inability of the blood to flow, the local velocity of the red blood cells in a microfluidic device was measured with a selected minimal channel width. The pressure difference was controlled by driving a steady flow of blood using a constant hydrostatic head, and the time for occlusion was determined as a function of ambient oxygen concentration. Since occlusion is a dynamical event, a maximum threshold time for occlusion of ten minutes was chosen as an extreme physiological limit. Maximum transit times of red blood cells through individual human vascular beds have been shown to take up to at least one minute (MacNee, W., Martin, B. A., Wiggs, B. R., Belzberg, A. S., & Hogg, J. C. (1989) J Appl Physiol 66, 844-850). This time was increased by a factor of ten to accommodate the possibility of in vivo subpopulations with even more extreme transit times and the possibility of traversing multiple vascular beds. The experiments described herein allowed the characterization of the phase space of occlusion or jamming using three coordinates: the minimum channel width in the microfluidic device, the total hydrostatic pressure difference across the device, and the ambient oxygen concentration.

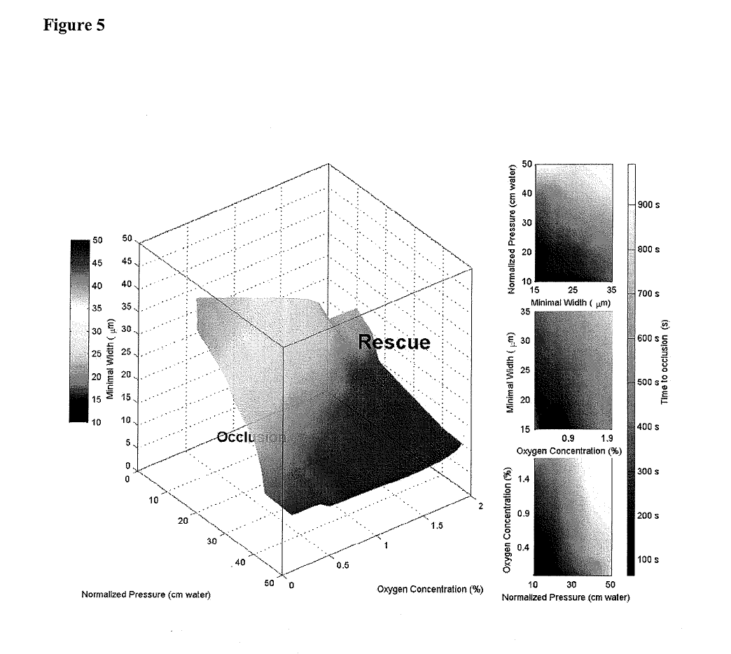

FIG. 5 shows a phase diagram where the volume between the coordinate planes and the curved surface shown defines the parameter space where occlusive events would be expected to occur within 10 minutes. Similar approximately-parallel isosurfaces (not depicted) define the boundary of differing temporal thresholds for occlusion. For unaffected individuals with 100% hemoglobin A (HbA), all fixed-time isosurfaces are located very close to the origin because the time to occlusion becomes very large almost regardless of pressure, oxygen, and vessel width. Conversely, increasing the concentration of HbS yields a phase space with fixed-time isosurfaces farther from the origin, thereby enclosing a wider range of parameter states where occlusion would occur.

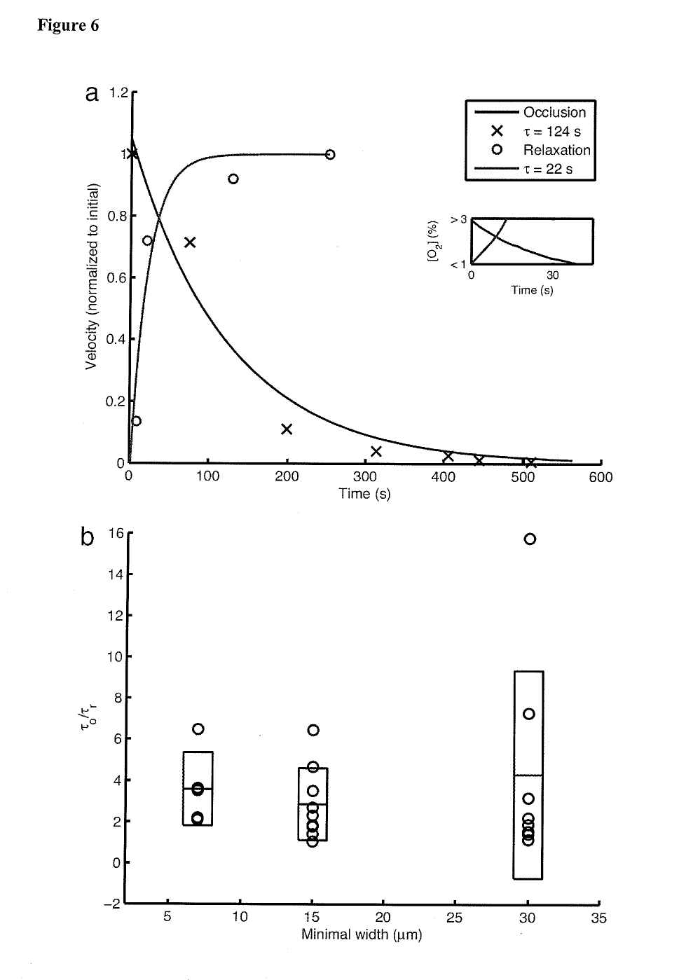

FIG. 6a shows that rescue occurs over a much shorter time scale than occlusion. This dynamical asymmetry or hysteresis between occlusion and rescue events is a robust result that occurs in more than 95% of the experiments. The evolution of the vaso-occlusive event was highly stochastic with large variations about the mean time for jamming under a fixed set of control parameters. This heterogeneity could arise from at least two sources: the highly cooperative nature of the HbS polymerization reaction whose onset is very slow relative to the subsequent explosive growth (Mozzarelli, A., Hofrichter, J., & Eaton, W. A. (1987) Science 237, 500-506; and Ferrone, F. A. (2004) Microcirculation 11, 115-128) and the hydrodynamics of highly-concentrated suspensions that are well known to jam (Liu, A. J. and Nagel, S. eds. (2001) Jamming and Rheology. (Taylor and Francis, London); and Berger, S. A. & King, W. S. (1980) Biophys J 29, 119-148). The degree of hysteresis between the occlusion and rescue events was quantified by calculating the ratio between the characteristic time to occlusion (τₒ) and the characteristic time to relaxation (τᵣ), defined as the time required to reach half of the maximum velocity. FIG. 6b shows that as the size of the minimal channel width increases beyond the red blood cell diameter of about 7 μm there is a significant increase in the variability of this ratio. In the devices with minimal channel width comparable to the size of a red blood cell, the ratio of the characteristic time to occlusion to that for rescue is more consistent across experiments. The effect of a sudden decrease in deformability caused by deoxygenation and polymerization alone is not sufficient to initiate an occlusive event in all but the narrowest channels; in addition one needs multiple cells to form a stiff percolating network across the channel before there is a significant reduction in the velocity of the blood leading to vaso-occlusion and self-filtration of the plasma. The large variability in the characteristic occlusion times in larger channels as seen in FIG. 6b is a signature of the stochastic nature of the percolating process.

While jamming is a collective event, unjamming is not since oxygen diffuses rapidly through the channels so that the intracellular HbS fibers depolymerize making the cells more deformable fairly quickly (about 10 s) and flow starts. Less variability in the characteristic time for relaxation regardless of minimal channel size was expected. Since the polymerization processes typically occur in a few milliseconds when oxygen is quenched rapidly and are thus much faster than the flow processes leading to jamming that take hundreds of seconds, this hysteresis points to the crucial role of the hydrodynamics of the suspension of red blood cells in plasma as the rate-limiting step in the occlusive event in our microfluidic chip.

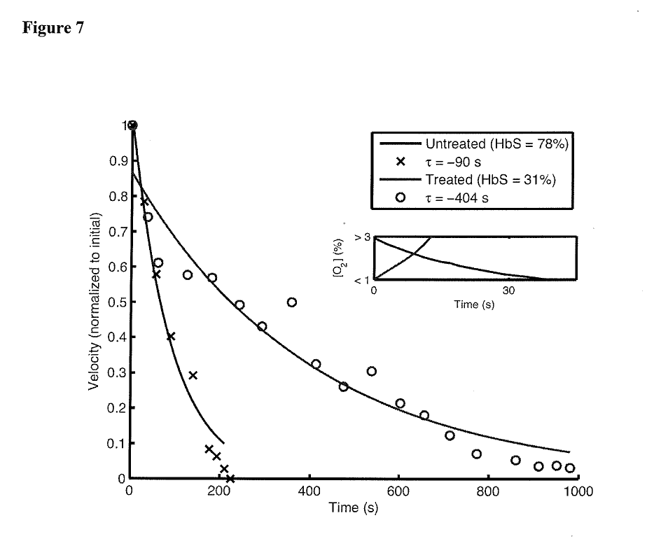

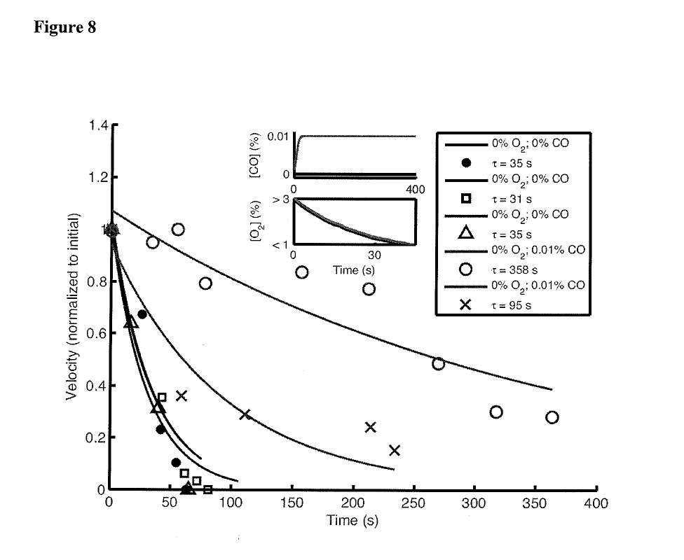

The device was also used to compare the flow velocity profiles of a patient sample before and after red cell exchange (or erythrocytapheresis), an established clinical procedure in which a sickle cell patient's blood is partially replaced with donor HbA-containing red blood cells. FIG. 7 quantifies the efficacy of the actual medical treatment of a patient with sickle cell disease: velocity of the treated specimen declines much more slowly following deoxygenation, and there is no actual occlusion. This assay could be used to help determine the optimal HbS fraction and hematocrit targets for the exchange procedure, and these optimal treatment goals could be individualized for each patient.

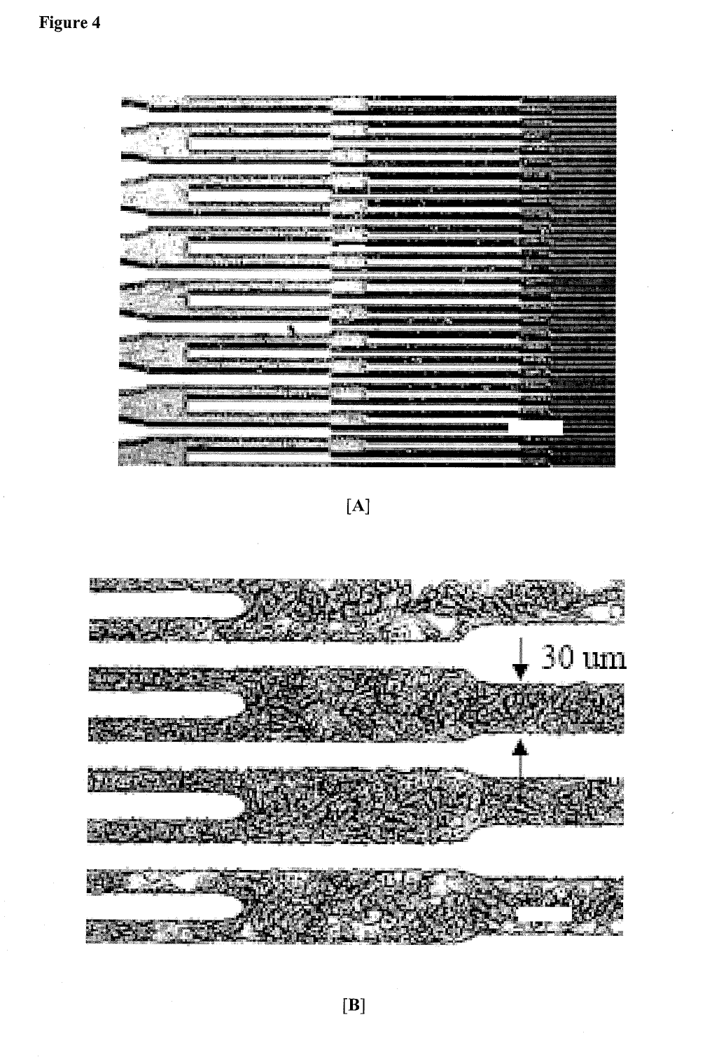

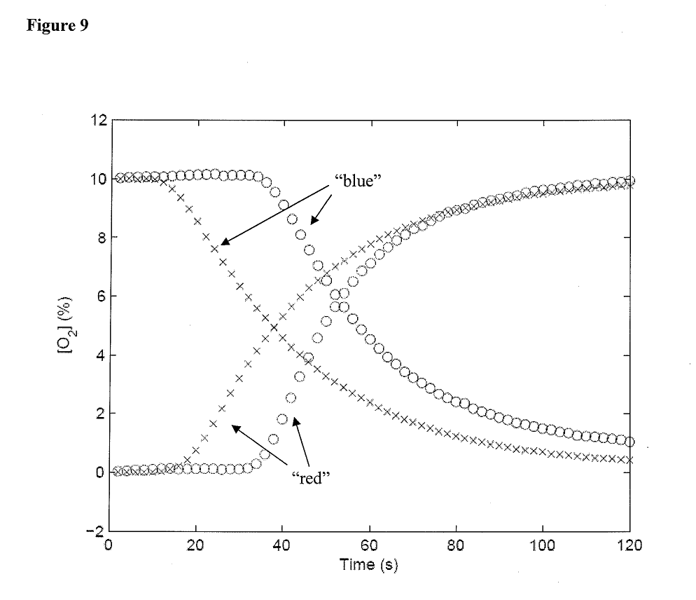

Finally, the impact of small molecule inhibitors of polymerization was invesitgated. Carbon monoxide (CO) binds to hemoglobin at least 200 times more tightly than oxygen and utilizes the same binding site, thus inhibiting polymerization (Mozzarelli, A., Hofrichter, J., & Eaton, W. A. (1987) Science 237, 500-506). The velocity profiles in FIG. 4b show that small concentrations of CO (0.01%) are sufficient to prevent an occlusion even when the ambient oxygen concentration is 0%. We also evaluated the effect of two solid small molecules, phenylalanine and a 2,3 diphosphoglycerate analog. These molecules did not cause a significant change in occlusion profiles (FIG. 9), but these studies demonstrate the potential use of this device to identify novel treatments for sickle cell disease.

As described above, the vaso-occlusive pathophysiology of sickle cell disease can be captured in a minimal microfluidic environment using a variety of geometrical, physical, chemical, and biological controls. While adhesion, endothelial phenotype, inflammation, etc., are likely to be contributors in vivo, the role of collective macroscopic suspension hydrodynamics on occlusive events, and the phase diagram quantifies the parameter space associated with a potential occlusion by integrating the evolution of HbS polymerization, highlight the change in the shape and elasticity of individual red blood cells, and their collective flow properties. Repeated cycles of sickling on larger time scales in vivo may lead to endothelial and inflammatory responses (Berger, S. A. & King, W. S. (1980) Biophys J29, 119-148; and Runyon, M. K., Johnson-Kerner, B. L., & Ismagilov, R. F. (2004) Angew Chem Int Ed Engl 43, 1531-1536) and cause additional positive feedback; however as is disclosed, it is possible to evoke and revoke an occlusive event in a minimal physiologically relevant system that does not require these processes to be at work.

From a scientific perspective, the collective jamming seen in physical and social dynamical systems such as the flow of grains, suspensions, and traffic have biological analogs in vaso-occlusion as is disclosed, but are also likely to be relevant to platelet aggregation, malarial cell sequestration, lipid jamming in bilayers, etc. (Chien, S., King, R. G., Kaperonis, A. A., & Usami, S. (1982) Blood Cells 8, 53-64), where one has to consider events at multiple scales. From an engineering perspective, the minimal microfluidic environment also provides a context in which one can study a variety of blood flow problems (Runyon, M. K., Johnson-Kerner, B. L., & Ismagilov, R. F. (2004) Angew Chem Int Ed Engl 43, 1531-1536; and Whitesides, G. M. (2006) Nature 442, 368-373), and is easily modified to account for complex flow geometries and the incorporation of adhesion molecules (Makamba, H., Kim, J. H., Lim, K., Park, N., & Hahn, J. H. (2003) Electrophoresis 24, 3607-3619) and eventually endothelial cells. From a clinical perspective, the inventive devices allows one to measure the efficacy of treatments at the level of the individual patient, by quantifying the propensity for vaso-occlusion in terms of the phase diagram in FIG. 5, and thus determine optimal hematocrit and HbS fractions individualized for sickle cell patients undergoing red cell exchanges, and guide prophylactic treatments in special medical situations including pregnancy (Koshy, M., Burd, L., Wallace, D., Moawad, A., & Baron, J. (1988) N Engl J Med 319, 1447-1452) and elective surgery (Vichinsky, E. P., Haberkern, C. M., Neumayr, L., Earles, A. N., Black, D., Koshy, M., Pegelow, C., Abboud, M., Ohene-Frempong, K., & Iyer, R. V. (1995) N Engl J Med 333, 206-213). Additionally, the inventive devices allow the assessment of the dynamical efficacy of different regimens of traditional drugs such as hydroxyurea (Hankins, J. S., Ware, R. E., Rogers, Z. R., Wynn, L. W., Lane, P. A., Scott, J. P., & Wang, W. C. (2005) Blood 106, 2269-2275; and Nathan, D. G. (2002) J Pediatr Hematol Oncol 24, 700-703). Importantly, such microfluidic chips also provides tools for novel treatments of this crippling disease, including possible agents which partially and dynamically inhibit polymerization sufficiently to prevent vaso-occlusion without permanently binding to hemoglobin (Cohen, A. E. & Mahadevan, L. (2003) Proc Natl Acad Sci USA 100, 12141-12146).

### Quantification of Non-Equilibrium Fluctuations of Cellular Velocities

Herein is also disclosed that some of the altered flow properties discussed above are ensemble, collective, or “emergent” phenomena seen only in flowing blood. It has been observed that while individual isolated pathologic cells may not behave differently from individual isolated healthy cells, because human blood is a very dense suspension of red blood cells (i.e., cells comprise ˜40% of the blood volume), when blood is subjected to pressure in microvascular-sized channels the cells may behave differently depending on whether they are diseased or normal. Therefore, one aspect of the invention relates to using a microcirculatory device, as described herein, to examine blood cells (1) at the very high density (or hematocrit) seen in vivo, (2) in the context of physiologic pressure-driven flow, and/or (3) while confined in physiologic-sized channels. As described in more detail below, it is shown that a microcirculatory device of the invention allows one to quantify “ensemble” behaviors and thereby distinguish healthy and sickle cell blood cells. It follows that it is therefore possible that such devices as those described herein may be useful in the diagnosis, monitoring, and screening of drugs for any disease or condition which alters these ensemble flow properties, for example by changing the stiffness or compliance of individual red blood cells. Such diseases would include a number of infections such as, for example, malaria, as well as certain metabolic disorders and hematologic cancers.

It is known that the flow of blood through the circulatory system involves complex interactions of blood cells with each other and with the environment due to the combined effects of varying cell concentration, cell morphology, cell rheology, and confinement. These interactions were investigated in a minimal, quasi-two dimensional microfluidic setting by using computational morphologic image analysis and machine learning algorithms to quantify the non-equilibrium fluctuations of cellular velocities. The effective hydrodynamic diffusivity of normal and pathologic sickled blood cells was measured and compared.

Blood is a dense suspension of soft non-Brownian cells of unique importance. Red blood cells are the major component and are sufficiently large (radius of about 4 μm and thickness of about 1-2 μm) that the effects of thermal fluctuations are negligible, i.e. their equilibrium diffusivity is negligibly small:

$${D}_{thermal} = \frac{kT}{f} ∼ 0.1 {µm}^{2} \text{/} s$$

where f=viscous drag coefficient for a flat disk with radius 4 μm in water at room temperature (H. C. Berg, Random walks in biology (Princeton University Press, Princeton, N.J., 1993), pp. 152). However, when suspensions of these soft cells are driven by pressure gradients or subjected to shear, complex multi-particle interactions give rise to local concentration and velocity gradients which then drive fluctuating particle movements (N. Menon, D. J. Durian, Science 275, 1920 (March, 1997); E. C. Eckstein, D. G. Bailey, A. H. Shapiro, Journal of Fluid Mechanics 79, 191 (1977); and D. Leighton, A. Acrivos, Journal of Fluid Mechanics 181, 415 (August, 1987)). Nearly all studies to date focus on only the mean flow properties of blood. Since the rheology of suspensions in general is largely determined by the microstructure of the suspended particles (J. J. Stickel, R. L. Powell, Annual Review of Fluid Mechanics 37, 129 (2005)), it is essential to measure cellular dynamics simultaneously in order to understand how the microscopic parameters and processes are related to larger scale. Virchow first noted more than 100 years ago (V. Kumar, A. K. Abbas, N. Fausto, S. L. Robbins, R. S. Cotran, Robbins and Cotran pathologic basis of disease (Elsevier/Saunders, Philadelphia, ed. 7th, 2004)) that slow flow or stasis leads to coagulation or thrombosis, which are collective physiologic and pathologic processes where heterogeneity in cellular velocity and density may be crucial. However, there are no existing quantitative studies of the statistical dynamics of flowing blood, and few such studies of dense, pressure-driven suspensions of any kind.

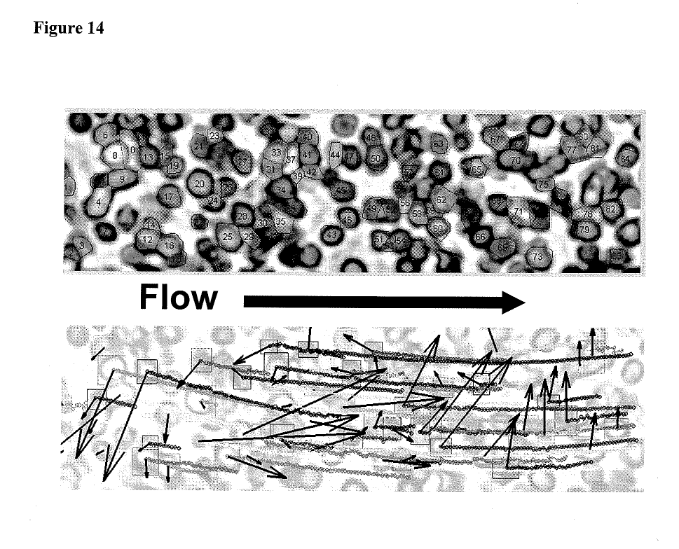

On the other hand, there is a large body of work characterizing the flow of dilute physical particulate sedimenting or sheared suspensions (A. Sierou, J. F. Brady, Journal of Fluid Mechanics 506, 285 (May, 2004); P. J. Mucha, S. Y. Tee, D. A. Weitz, B. I. Shraiman, M. P. Brenner, Journal of Fluid Mechanics 501, 71 (February 2004); and L. Bergougnoux, S. Ghicini, E. Guazzelli, J. Hinch, Physics of Fluids 15, 1875 (July, 2003)). To investigate the short-time dynamics of flowing red blood cells a computational morphologic image processing (P. Soille, Morphological image analysis: principles and applications (Springer, Berlin; New York, ed. 2nd, 2003), pp. xvi, 391 p.), and machine learning algorithms to segment and track individual blood cells in videos captured at high spatial and temporal resolution in a microfluidic device, was developed (FIG. 14). Individual cell trajectories comprised of more than 25 million steps across more than 500,000 video frames can be measured. These measurements enable one to ask and answer questions about the variability of velocity fluctuations at the scale of individual red blood cells, the effect of bulk flow velocity and density on the microscopic velocity fluctuations, and the role of collective behaviour under pathological conditions which alter these properties, such as in the case of sickle cell disease where red blood cell shape and deformability are changed.

Microfluidic devices with cross-sectional area of 250 μm×12 μm (as described elsewhere herein) were used. The 12 μm dimension of the microfluidic channels along one axis confines the cell movements in this direction; indeed the range of motion is already hydrodynamically limited by the Fahraeus effect (A. S. Popel, P. C. Johnson, Annual Review of Fluid Mechanics 37, 43 (2005)). One of the primary advantages of this quasi-two-dimensional experimental geometry is the ability to visualize the cells easily. Although this small dimension may limit the dynamics as compared to those of uniformly confined cells, such a system nevertheless enables the characterization and measurement of the statistical dynamics of both normal and pathologic blood flow. The device and blood parameters chosen are relevant to human physiology and pathology, and data was derived from the middle fifth of the 250 μm channel, where the velocity profile is essentially plug-like at these concentrations with no measurable bulk shear rate in the plane of analysis.

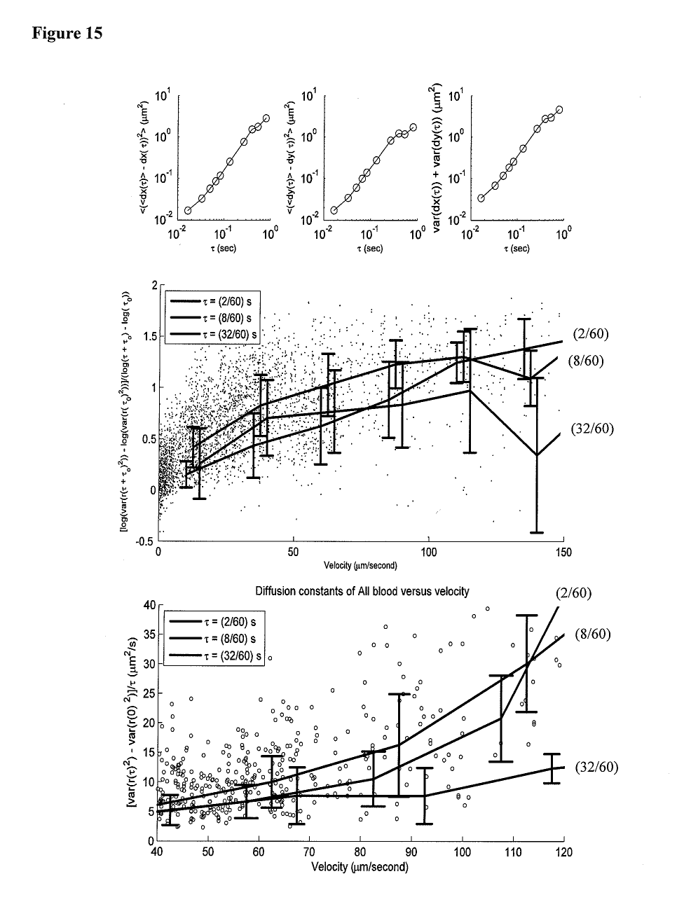

FIG. 15 quantifies the fluctuations of individual blood cells in terms of the mean-squared displacement, <Δr²(τ)>=<(r_{bulk}(τ)−r_{cell}(τ))²>, and shows that <Δr²(τ)>=Dτ. Thus, the dynamics are diffusive with an effective diffusion constant D different from and much larger than the equilibrium diffusivity. The movement of a cell in relation to the bulk at one instant is therefore not correlated with its subsequent movement, except over very short times relative to the time of interaction between cells. <Δr²(τ)> is roughly isotropic (<Δx²(τ)>˜<Δy²(τ)>) at shorter times, and then anisotropic at longer times with fluctuations parallel to the direction of flow 50% larger than perpendicular to it, a finding which is qualitatively consistent with experiments on physical particulate suspensions [N. Menon, D. J. Durian, Science 275, 1920 (March, 1997); and N. C. Shapley, R. A. Brown, R. C. Armstrong, Journal of Rheology 48, 255 (March-April, 2004). This diffusive behaviour is itself dynamical in its origin, being driven by the relative flow of fluid and cells. To understand this dependence, both the evolution of the scaling exponent

$$α = \frac{log 〈 Δ {r}^{2} ( τ ) 〉 - log D}{log τ}$$

as a function of the bulk flow velocity (V_{bulk}) and red blood cell concentration for more than 700 different experiments with different blood samples was measured. It was found that an increase in V_{bulk} from rest to about 50 μm/s is associated with a change in dynamics from stationary through sub-diffusive to diffusive, as shown in FIG. 15. However, over the range of densities studied (15%±45%) there was no consistent effect on the nature of the statistical cell dynamics, possibly because a relatively narrow range of densities relevant to human physiology and pathology was chosen.

A diffusive process has a characteristic length scale (X) corresponding to the mean free path that a cell travels before an interaction, and a characteristic time scale corresponding to the time between these interactions. A naïve estimate of X for blood flow might be half the distance between cells (about 3 μm at a two-dimensional density of 33%). At the low Reynolds numbers typical of microvasculature flows in vivo as well as in our experiments (where Re=0(0.01)), viscous effects from individual cells act over long ranges unless screened by the presence of lateral boundaries. Thus a cell will travel only a fraction of the inter-cellular distance before it interacts with another cell. The mean shear gradient (\dot{γ}) in the plane of analysis is zero (A. S. Popel, P. C. Johnson, Annual Review of Fluid Mechanics 37, 43 (2005)), yet cell velocities still fluctuate. These velocity fluctuations are driven by localized spatio-temporal fluctuations in shear gradient, i.e., [symbol] \dot{γ} [symbol] ≠0, and possibly also by a shear gradient normal to the plane of analysis (

$${\dot{γ}}_{normal} ∼ \frac{{V}_{bulk}}{h / 2} ∼ 10 {s}^{- 1}$$

and thus

$$\frac{D}{κ} ∼ \frac{{V}_{bulk}}{h} {r}^{2} ∼ 90 \frac{{µm}^{2}}{s}$$

with κ˜0.1.) In the absence of a microscopic theory, we propose a simple qualitative explanation: particles slow down and speed up by an amount proportional to the bulk velocity when they interact with each other over a scale comparable to their mean separation. Then simple dimensional reasoning suggests that:

$${\dot{γ}}_{rm s} = \sqrt{〈 {\dot{γ}}^{2} 〉} = κ \frac{{V}_{bulk}}{λ} \qquad ( Eq . 1 )$$

where the dimensionless prefactor κ captures the effect of cell shape and stiffness. Therefore the velocity with which each cell executes its random walk scales as \dot{γ}ᵣₘₛλ so that D˜\dot{γ}ᵣₘₛλ²˜κV_{bulk}λ. For a typical bulk velocity, V_{bulk}˜50 μm/s, the measured D≈8 μm²/s,

$$κ \approx \frac{1}{20} ,$$

and λ=0.24 μm. See FIG. 15. Cells in flows with slower V_{bulk} will have smaller <Δr²(τ)> and therefore will not appear diffusive unless they are sampled for longer times. Over times shorter than

$$\frac{λ}{{V}_{bulk}} ,$$

<Δr²(τ)> will show a mixed character including ballistic dynamics, though this effect in our results is dominated by the fact that extremely small displacements are below our analytic sensitivity and appear as stasis.

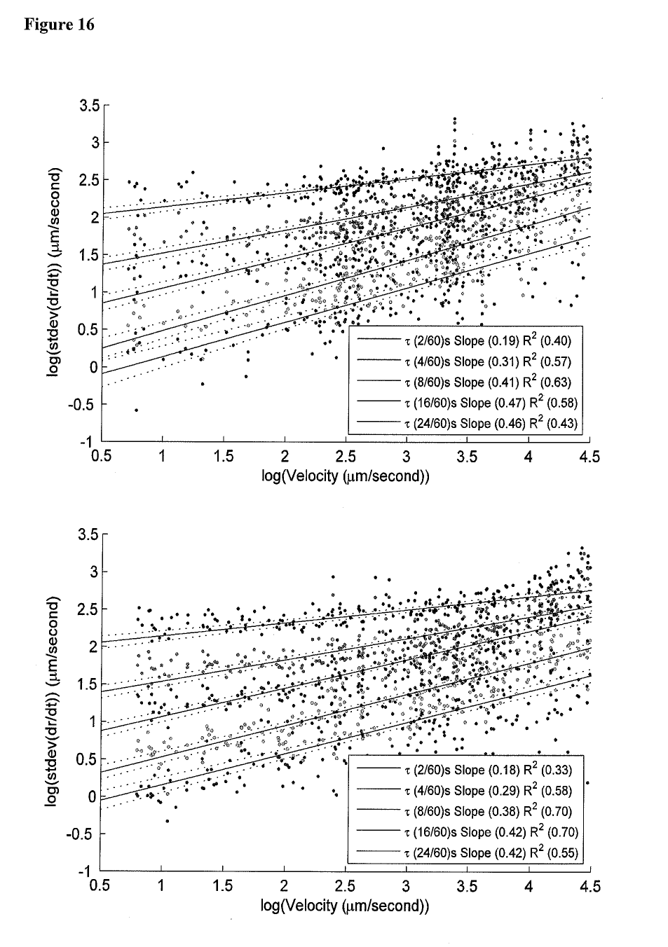

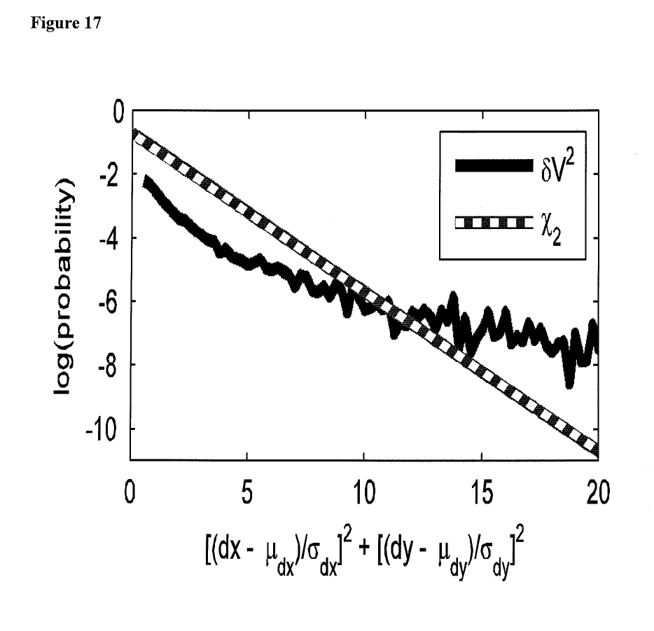

Since it is likely that cell shape and stiffness are important determinants of microscopic cellular velocity fluctuations, the behaviour of blood cells from patients with sickle cell disease was measured. Red blood cells from these patients become stiff in deoxygenated environments as a result of the polymerization of a variant hemoglobin molecule (W. A. Eaton, J. Hofrichter, Adv Protein Chem 40, 63 (1990)), resulting in a dramatic increase in the risk of sudden vaso-occlusive events with a poorly understood mechanism (H. F. Bunn, N Engl J Med 337, 762 (Sep. 11, 1997)). The relationship between V_{bulk} and the root mean squared velocity fluctuation δᵣₘₛ(t)=\sqrt{ [symbol](V_{bulk}−V_{cell})² [symbol]} for normal blood as well as sickle cell blood both with and without oxygen was compared. The results for oxygenated and deoxygenated sickle cells are shown in FIG. 16. δVᵣₘₛ(t) for all three sample types is larger over shorter times as is expected for a diffusive process where

$$δ {V}_{rms} ( t ) = \sqrt{\frac{{\dot{γ}}_{rms} {λ}^{2}}{t}} = \sqrt{\frac{κ {V}_{bulk} λ}{t}} \qquad ( Eq . 2 )$$

approaches zero over longer times, as individual cellular velocities regress to the mean. Because one expects velocity fluctuations to depend on V_{bulk}, the behavior suggested by (Eq. 2) where

$$β ( t ) = \frac{log δ {V}_{r m s} t - log κ λ}{log {V}_{bulk}}$$

asymptotes to ½, was measured. For very short times or very slow bulk flow rates, cell displacements are below the detection limits of the experimental system, and the residual noise is independent of V_{bulk} and β=0. For intermediate flow velocities, deoxygenated sickle cell blood takes longer to reach this asymptote. The variation in typical velocity fluctuations around the linear fit for any given time scale is significant, but the trend at each time scale is consistent across sample types. At all time scales considered, βₙₒᵣₘₐₗ>β_{sickle oxygenated}>βP_{sickle deoxygenated}. A fixed increase in bulk flow velocity in this range is associated with a smaller increase in cellular velocity fluctuations for deoxygenated sickle cells than for the others. Therese results therefore imply that κ_{deoxygenated}<κ_{oxygenated}: this smaller κ_{deoxygenated}, which characterizes cellular morphology and rheology, yields a reduced diffusivity, reflecting a random walk with a shorter mean free path relative to the mean free time.

These results may be interpreted in the language of the statistical physics of driven suspensions (N. C. Shapley, R. A. Brown, R. C. Armstrong, Journal of Rheology 48, 255 (March-April, 2004); and P. R. Nott, J. F. Brady, Journal of Fluid Mechanics 275, 157 (September, 1994)) by defining an effective temperature in terms of the mean squared molecular or fluctuating velocity <δV(t)²>. An increase in V_{bulk} is then associated with an increase in the effective temperature. In FIG. 16, the measured probability distribution of δV² is shown and it can be seen that it has longer tails than an equilibrium Maxwell-Boltzmann distribution owing to the non-equilibrium nature of the system, consistent with observations in physical suspensions (N. Menon, D. J. Durian, Science 275, 1920 (March, 1997); and N. C. Shapley, R. A. Brown, R. C. Armstrong, Journal of Rheology 48, 255 (March-April, 2004)). One may nevertheless use the crude analogy of an effective temperature to characterize “hot” blood flow which has increased <δV²(t)> and is less likely to coagulate or “freeze” than is a “cold” blood flow where cells are not fluctuating and local stasis is more likely to arise and to persist. Virchow's Triad (V. Kumar, A. K. Abbas, N. Fausto, S. L. Robbins, R. S. Cotran, Robbins and Cotran pathologic basis of disease (Elsevier/Saunders, Philadelphia, ed. 7th, 2004)) implicates stasis as one of the conditions leading to thrombosis and may explain why pathologic blood with smaller cellular fluctuations will coagulate at flow rates where normal blood will not.

The positive feedback between increasing V_{bulk} and increasing δVᵣₘₛ(t) shown here may provide a mechanism for the unexplained asymmetry between vaso-occlusion and its rescue, as disclosed herein. The initial increase in V_{bulk} during clot dissolution will augment δVᵣₘₛ which then further disrupts the occlusive plug, resulting in greater V_{bulk} and even greater δVᵣₘₛ(t) and positive feedback. The rescue process will therefore evolve much more quickly than the reverse process of occlusion, creating an asymmetry in time scales.

Thus, quantitative differences in velocity fluctuations as a function of blood flow rate, shape, and stiffness may be involved in the collective processes of coagulation and thrombosis.

### Selected Devices and Methods of the Invention

One aspect of the invention relates to an integrated microfluidic device comprising: a plurality of interconnected channels comprising a sample inlet and a sample outlet; a gas reservoir comprising at least one gas inlet and at least one gas outlet; and a gas-permeable membrane positioned between said plurality of interconnected channels and said gas reservoir; wherein said plurality of interconnected channels, said gas-permeable membrane and said gas reservoir are positioned to allow gas diffusion from said gas reservoir, through said gas-permeable membrane, into said plurality of interconnected channels.

Another aspect of the invention relates to an integrated microfluidic device comprising: a plurality of interconnected channels comprising a sample inlet and a sample outlet; a gas reservoir comprising at least one gas inlet and at least one gas outlet; and a gas-permeable membrane positioned between said plurality of interconnected channels and said gas reservoir; wherein said plurality of interconnected channels, said gas-permeable membrane and said gas reservoir are positioned to allow gas diffusion from said gas reservoir, through said gas-permeable membrane, into said plurality of interconnected channels; and the volume of space occupied by the integrated microfluidic device is less than about 80,000 mm³.

In certain embodiments, the invention relates to an aforementioned integrated microfluidic device, wherein said plurality of interconnected channels are formed from a first channel which bifurcates into two second channels.

In certain embodiments, the invention relates to an aforementioned integrated microfluidic device, wherein said plurality of interconnected channels are formed from a first channel which bifurcates into two second channels; and the cross-sectional area of the first channel is equal to the sum of the cross-sectional areas of the two second channels.

In certain embodiments, the invention relates to an aforementioned integrated microfluidic device, wherein said plurality of interconnected channels are formed from a first channel which bifurcates into two second channels; the cross-sectional area of the first channel is equal to the sum of the cross-sectional areas of the two second channels; and the cross-sectional areas of each of the two second channels are substantially similar.

One skilled in the art will appreciate that the resulting two second channels can be likewise bifurcated, and the process can continue to form a variety of plurality of interconnected channels. The invention encompasses all such bifurcation schemes, including those specifically described below.

In certain embodiments, the invention relates to an aforementioned integrated microfluidic device, wherein the channels in said plurality of interconnected channels intersect; and each intersection is a three way junction.

In certain embodiments, the invention relates to an aforementioned integrated microfluidic device, wherein said channels have substantially similar cross-sectional areas.

In certain embodiments, the invention relates to an aforementioned integrated microfluidic device, wherein said sample inlet leads to a channel of said plurality of interconnected channels which bifurcates two, three, four, five, six, seven, eight, nine, or ten times.

In certain embodiments, the invention relates to an aforementioned integrated microfluidic device, wherein the cross sectional area of said first channel is between about 2000 μm² and about 6000 μm².

In certain embodiments, the invention relates to an aforementioned integrated microfluidic device, wherein the cross sectional area of said first channel is about 4000 μm².

In certain embodiments, the invention relates to an aforementioned integrated microfluidic device, wherein each channel in said plurality of interconnected channels is tube like.

In certain embodiments, the invention relates to an aforementioned integrated microfluidic device, wherein each channel in said plurality of interconnected channels is curved. While many of the examples provided herein have channels that are straight or angular, this should in no way be construed as limiting as the present invention also includes devices with channels which are curved or tortuous. For example, the present invention includes devices where the channels are not parallel, or devices where the channels intersect or recombine in a less orderly way that then examples provided.

In certain embodiments, the invention relates to an aforementioned integrated microfluidic device, wherein the cross-sectional shape of each channel in said plurality of interconnected channels is circular.

In certain embodiments, the invention relates to an aforementioned integrated microfluidic device, wherein said plurality of interconnected channels further comprises a detection region.

In certain embodiments, the invention relates to an aforementioned integrated microfluidic device, wherein the thickness of said gas reservoir is between about 10 μm and about 500 μm.

In certain embodiments, the invention relates to an aforementioned integrated microfluidic device, wherein the thickness of said gas reservoir is between about 50 μm and about 250 μm.

In certain embodiments, the invention relates to an aforementioned integrated microfluidic device, wherein the thickness of said gas reservoir is about 150 μm.

In certain embodiments, the invention relates to an aforementioned integrated microfluidic device, wherein said gas-permeable membrane comprises silicone rubber, polydimethylsiloxane, polytetrafluorethylene, polypropylene, polysulfone, dimethyl siloxane or methyvinyl siloxane.

In certain embodiments, the invention relates to an aforementioned integrated microfluidic device, wherein said gas-permeable membrane is polydimethylsiloxane.

In certain embodiments, the invention relates to an aforementioned integrated microfluidic device, wherein the thickness of said gas-permeable membrane is between about 10 μm and about 500 μm.

In certain embodiments, the invention relates to an aforementioned integrated microfluidic device, wherein the thickness of said gas-permeable membrane is between about 50 μm and about 250 μm.

In certain embodiments, the invention relates to an aforementioned integrated microfluidic device, wherein the thickness of said gas-permeable membrane is about 150 μm.

In certain embodiments, the invention relates to an aforementioned integrated microfluidic device, wherein the gas-permeable membrane is attached to the gas reservoir.

In certain embodiments, the invention relates to an aforementioned integrated microfluidic device, wherein the volume of space occupied by the integrated microfluidic device is less than about 40,000 mm³.

In certain embodiments, the invention relates to an aforementioned integrated microfluidic device, wherein the volume of space occupied by the integrated microfluidic device is less than about 20,000 mm³.

In certain embodiments, the invention relates to an aforementioned integrated microfluidic device, wherein the shape of said integrated microfluidic device is a square prism, a rectangular prism, a cylinder, a sphere, a disc, a slide, a chip, a film, a plate, a pad, a tube, a strand, or a box.

In certain embodiments, the invention relates to an aforementioned integrated microfluidic device, wherein said integrated microfluidic device is substantially flat with optional raised, depressed or indented regions to allow ease of manipulation.

Another aspect of the invention relates to a method for conducting an analysis, comprising the steps of: introducing a sample into a sample inlet of an integrated microfluidic device; wherein said integrated microfluidic device comprises a plurality of interconnected channels comprising said sample inlet and a sample outlet; a gas reservoir comprising at least one gas inlet and at least one gas outlet; and a gas-permeable membrane positioned between said plurality of interconnected channels and said gas reservoir; wherein said plurality of interconnected channels, said gas-permeable membrane and said gas reservoir are positioned to allow gas diffusion from said gas reservoir, through said gas-permeable membrane, into said plurality of interconnected channels; and passing said sample through said plurality of interconnected channels.

Yet another aspect of the invention relates to a method for conducting an analysis, comprising the steps of: introducing a first sample into a sample inlet of an integrated microfluidic device; wherein said integrated microfluidic device comprises a plurality of interconnected channels comprising said sample inlet and a sample outlet; a gas reservoir comprising at least one gas inlet and at least one gas outlet; and a gas-permeable membrane positioned between said plurality of interconnected channels and said gas reservoir; wherein said plurality of interconnected channels, said gas-permeable membrane and said gas reservoir are positioned to allow gas diffusion from said gas reservoir, through said gas-permeable membrane, into said plurality of interconnected channels; and the volume of space occupied by the integrated microfluidic device is less than about 80,000 mm³; and passing said first sample through said plurality of interconnected channels.

In certain embodiments, the invention relates to an aforementioned method, further comprising the step of: observing the fluid dynamical behavior of the first sample, while the first sample is passing through one channel in said plurality of interconnected channels.

In certain embodiments, the invention relates to an aforementioned method, further comprising the step of introducing a gas into said gas reservoir through said gas inlet.

In certain embodiments, the invention relates to an aforementioned method, further comprising the steps of introducing a gas into said gas reservoir through said gas inlet; and measuring the oxygen content of the gas which passes through said gas outlet.

In certain embodiments, the invention relates to an aforementioned method, wherein said first sample is passed through said plurality of interconnected channels using gravity-driven flow.

In certain embodiments, the invention relates to an aforementioned method, wherein said first sample comprises blood.

In certain embodiments, the invention relates to an aforementioned method, wherein said first sample comprises fractionated blood.

In certain embodiments, the invention relates to an aforementioned method, wherein said first sample comprises blood and deionized water.

In certain embodiments, the invention relates to an aforementioned method, wherein said first sample comprises blood and concentrated sucrose.

In certain embodiments, the invention relates to an aforementioned method, wherein said first sample comprises hemoglobin.

In certain embodiments, the invention relates to an aforementioned method, wherein said first sample comprises a blood substitute. Blood substitutes, often called artificial blood, are used to fill fluid volume and/or carry oxygen and other blood gases in the cardiovascular system. Examples of blood substitutes include Oxygent (Alliance Pharmaceutical), Hemopure (Biopure Corp.), Oxyglobin (Biopure Corp.), PolyHeme (Northfield Laboratories), Hemospan (Sangart), Dextran-Hemoglobin (Dextro-Sang Corp), and Hemotech (HemoBiotech).

In certain embodiments, the invention relates to an aforementioned method, wherein said first sample is blood.

A variety of diseases and disorders can manifest in the blood. An infection of the blood is known as sepsis. There are many different microbes can cause sepsis. Although bacteria are most commonly the cause, viruses and fungi can also cause sepsis. Infections in the lungs (pneumonia), bladder and kidneys (urinary tract infections), skin (cellulitis), abdomen (such as appendicitis), and other organs (such as meningitis) can spread and lead to sepsis. Infections that develop after surgery can also lead to sepsis.

A hematological cancer, such a leukemia, occurs due to errors in the genetic information of an immature blood cell. The immature cell replicates over and over again, resulting in a proliferation of abnormal blood cells. These abnormal cells or cancer cells

In certain embodiments, the invention relates to an aforementioned method, wherein said first sample is blood from a patient afflicted with a genetic blood disorder, disorders of white blood cells, disorders of blood platelets and coagulation, an infection (such as sepsis), a metabolic disorder or a hematological cancer.

In certain embodiments, the invention relates to an aforementioned method, wherein said first sample is blood from a patient afflicted with sickle cell disease, malaria, metabolic acidosis, Burkitt lymphoma, Gaucher disease, hemophilia A, hemophilia B, chronic myeloid leukemia, Niemann-Pick disease, paroxysmal nocturnal hemoglobinuria, porphyria, thalassemia, hereditary spherocytosis, Waldenstrom's macroglobulinemia, leukocytosis, activated protein C resistance, or thrombocythemia

In certain embodiments, the invention relates to an aforementioned method, wherein said first sample is blood from a patient afflicted with sickle cell disease.

In certain embodiments, the invention relates to an aforementioned method, wherein said first sample is blood from a patient afflicted with malaria.

In certain embodiments, the invention relates to an aforementioned method, wherein said first sample is blood from a patient afflicted with early-stage malaria.

In certain embodiments, the invention relates to an aforementioned method, wherein said first sample is blood from a patient afflicted with malaria, and said analysis is used to define different strains of the malaria parasite and/or quantify the pathogenicity in said patient.

In certain embodiments, the invention relates to an aforementioned method, further comprising the step of filling said plurality of interconnected channels with water.

In certain embodiments, the invention relates to an aforementioned method, wherein the channels in said plurality of interconnected channels intersect; and each intersection is a three way junction.

In certain embodiments, the invention relates to an aforementioned method, wherein said channels have substantially similar cross-sectional areas.

In certain embodiments, the invention relates to an aforementioned method, wherein said sample inlet leads to a channel of said plurality of interconnected channels which bifurcates two, three, four, five, six, seven, eight, nine, or ten times.

In certain embodiments, the invention relates to an aforementioned method, wherein the cross sectional area of said first channel is between about 20,000 μm² and about 60,000 μm².

In certain embodiments, the invention relates to an aforementioned method, wherein the cross sectional area of said first channel is about 40,000 μm².

In certain embodiments, the invention relates to an aforementioned method, wherein each channel in said plurality of interconnected channels is tube like.

In certain embodiments, the invention relates to an aforementioned method, wherein each channel in said plurality of interconnected channels is curved.

In certain embodiments, the invention relates to an aforementioned method, wherein the cross-sectional shape of each channel in said plurality of interconnected channels is circular.

In certain embodiments, the invention relates to an aforementioned method, wherein said plurality of interconnected channels further comprises a detection region.

In certain embodiments, the invention relates to an aforementioned method, wherein the thickness of said gas reservoir is between about 10 μm and about 500 μm.

In certain embodiments, the invention relates to an aforementioned method, wherein the thickness of said gas reservoir is between about 50 μm and about 250 μm.

In certain embodiments, the invention relates to an aforementioned method, wherein the thickness of said gas reservoir is about 150 μm.

In certain embodiments, the invention relates to an aforementioned method, wherein said gas-permeable membrane comprises silicone rubber, polydimethylsiloxane, polytetrafluorethylene, polypropylene, polysulfone, dimethyl siloxane or methyvinyl siloxane.

In certain embodiments, the invention relates to an aforementioned method, wherein said gas-permeable membrane is polydimethylsiloxane.

In certain embodiments, the invention relates to an aforementioned method, wherein the thickness of said gas-permeable membrane is between about 10 μm and about 500 μM.

In certain embodiments, the invention relates to an aforementioned method, wherein the thickness of said gas-permeable membrane is between about 50 μm and about 250 μm.

In certain embodiments, the invention relates to an aforementioned method, wherein the thickness of said gas-permeable membrane is about 150 μm.

In certain embodiments, the invention relates to an aforementioned method, wherein the gas-permeable membrane is attached to the gas reservoir.

In certain embodiments, the invention relates to an aforementioned method, wherein the volume of space occupied by the integrated microfluidic device is less than about 40,000 mm³.

In certain embodiments, the invention relates to an aforementioned method, wherein the volume of space occupied by the integrated microfluidic device is less than about 20,000 mm³.

In certain embodiments, the invention relates to an aforementioned method, wherein the shape of said integrated microfluidic device is a square prism, a rectangular prism, a cylinder, a sphere, a disc, a slide, a chip, a film, a plate, a pad, a tube, a strand, or a box.

In certain embodiments, the invention relates to an aforementioned method, wherein said integrated microfluidic device is substantially flat with optional raised, depressed or indented regions to allow ease of manipulation.

In certain embodiments, the invention relates to an aforementioned method, further comprising the steps of: introducing a second sample into a sample inlet of the integrated microfluidic device; and passing said second sample through said plurality of interconnected channels.

In certain embodiments, the invention relates to an aforementioned method, further comprising the step of: observing changes in the fluid dynamical behavior of the second sample, while the second sample is passing through one channel in said plurality of interconnected channels.

In certain embodiments, the invention relates to an aforementioned method, wherein said second sample is passed through said plurality of interconnected channels using gravity-driven flow.

In certain embodiments, the invention relates to an aforementioned method, wherein said second sample comprises blood.

In certain embodiments, the invention relates to an aforementioned method, wherein said second sample comprises fractionated blood.

In certain embodiments, the invention relates to an aforementioned method, wherein said second sample comprises blood and deionized water.

In certain embodiments, the invention relates to an aforementioned method, wherein said second sample comprises blood and concentrated sucrose.

In certain embodiments, the invention relates to an aforementioned method, wherein said second sample is blood.

In certain embodiments, the invention relates to an aforementioned method, wherein said second sample is blood from a patient not afflicted with a genetic blood disorder, an infection, a metabolic disorder or a hematological cancer.

In certain embodiments, the invention relates to an aforementioned method, wherein said second sample is blood from a patient not afflicted with sickle cell disease.

In certain embodiments, the invention relates to an aforementioned method, wherein said second sample is blood from a patient not afflicted with malaria.

### EXEMPLIFICATION

The invention now being generally described, it will be more readily understood by reference to the following examples, which are included merely for purposes of illustration of certain aspects and embodiments of the present invention, and are not intended to limit the invention.

The selected embodiment of the invention discussed in the previous section, and further described in following Exemplification, is shown in FIG. 4. Specifically, an in vitro model of a sickle cell vaso-occlusive crisis by flowing sickle cell blood through the device under low oxygen concentrations is described below. Therein it is shown that: the deoxygenation of HbS allows polymerization; polymerization reduces deformability, these cells then block flow through the channels; and, remarkably, the occlusion can be reversed by increasing the oxygen concentration in the gas channels.

### Example 1

Blood Specimens. Blood specimens were collected during the normal course of patient care at Brigham and Women's Hospital and used in experiments in accordance with a research protocol approved by the Partners Healthcare Institutional Review Board. Blood samples were collected in 5 mL EDTA vacutainers and stored at 4° C. for up to 60 days. Hematocrit was determined using a Bayer Advia 2120 automated analyzer (Bayer, Tarrytown, N.Y.). Hemoglobin fractions were determined using cellulose agar electrophoresis and confirmed by HPLC using a Tosoh G7 column (Tosoh, Tokyo, Japan).

### Example 2

Fabrication of Microfluidic Devices. A multilayered microfluidic network was fabricated in poly(dimethylsiloxane) (PDMS) using previously described soft lithography techniques. Duffy, D., J. McDonald, et al. (1998). “Rapid prototyping of microfluidic systems in poly(dimethylsiloxane).” Analytical Chemistry 70(23): 4974-4984. The multilayered device consists of a 150 μm thick gas reservoir separated from a 12 μm vascular network by a 150 μm PDMS membrane. SU8 photoresist (Microchem, Newton, Mass.) was used to fabricate the mold masters for both the vascular and gas channels. The vascular network was fabricated to be 12 μm thick by spin coating SU8-2015 onto a 4-inch silicon wafer at 3000 rpm for 30 seconds. This wafer was then softbaked at 65° C. for 1 minute and 95° C. for two minutes. Next the SU8 coated substrate was placed into soft contact with a high-resolution transparency photomask and exposed with UV (365 nm) light at 100 mJ/cm². This substrate was then hardbaked at 65° C. for 1 minute and 95° C. for 2 minutes to complete the cross-linking process. The wafer was allowed to cool to room temperature and developed in Microchem's SU8 developer. The gas channels were fabricated to be 150 μm thick through similar techniques with the exceptions of slower spin velocity (1200 rpm), longer softbakes (65° C. for 7 minutes and 95° C. for 60 minutes), more energy for exposure (400 mJ/cm²), and a longer hardbake (65° C. for 1 minute and 95° C. for 15 minutes).

Once the mold masters were fabricated, PDMS (sylgard 184, Dow Corning, Midland, Mich.) was prepared by mixing the PDMS pre-polymer and cross-linker in a 10:1 ratio followed by degassing for 1 hour to remove air bubbles, and curing at 75° C. for 90 minutes. The assembly of the device is shown in FIG. 2. The 150 μm thick PDMS membrane was patterned with the vascular network by first pouring 5 mL of PDMS onto the vascular network mold master. Next, a transparency was placed onto the PDMS to facilitate removal from the 4″ glass plate which is used to ensure a uniform pressure distribution over the mold master. Finally 500 g of compression weights were placed onto the glass plate. The 150 μm gas reservoir was molded in a 5 mm thick block of PDMS with holes for tubing connections cored with a 12-gauge syringe needle. The patterned PDMS membrane was first attached to the gas reservoir and then bonded to a glass slide using an oxygen plasma system (PlasmaPreen, Terra Universal, Fullerton, Calif.) to activate the surfaces prior to bonding. After bonding, the devices were placed in an oven at 75° C. overnight to improve bonding strength and stabilize material properties. Eddington, D. T., J. P. Puccinelli, and D. J. Beebe (2006). “Thermal aging and reduced hydrophobic recovery of polydimethylsiloxane.” Sensors and Actuators B-Chemical 114(1): 170-172. The bonded devices were placed in a dessicator for 5 minutes prior to filling to reduce bubble formation. The devices were first filled with water to facilitate the use of high pressures to drive out remaining air bubbles without the risk of dealing with potentially infectious human blood samples under high pressures. Once the device was initially primed with water, blood was easily injected into the device using gravity-driven flow.

### Example 3

Experimental Setup. The assembled microfluidic device was mounted on an inverted microscope (Nikon TE-3000) and the fluidic and gas sources were connected as shown in FIG. 2. The microfluidic channels begin 4 mm wide, then split into roughly equal total cross section areas until the smallest dimension (7, 15, 30, or 60 μm) which then traverses 4 cm until the channels recombine sequentially at the outlet. The blood velocity was monitored most often in the 250 μm channels which were fed by 4 60-μm, 8 30-μm, 16 15-μm, or 16 7-μm channels depending on the device studied. Two rotometers controlled the gas mixture fed through the oxygen channels. The gas mixture diffuses rapidly through PDMS to initiate occlusion or flow. The outlet gas concentration was monitored with a fluorescent oxygen probe (FOXY Fiber Optic Oxygen Sensor, Ocean Optics, Dunedin, Fla.) to monitor the gas concentrations within the gas microchannels. Gravity-driven flow was used to inject blood into the vascular network and resulted in flow rates up to 500 μm/second.

Over 100 different such occlusion assays were performed, capturing more than 1000 videos with more than 100,000 total frames. Given a device with a particular minimal width (7, 15, 30, or 60 μm), a patient blood specimen with a known hemoglobin S fraction and a known red blood cell concentration was followed. The pressure difference was modulated by changing the height of the pressure head and modulated the gas concentration in the fluid channel by adjusting the gas mixture flowing through the adjacent gas channels. Videos were captured at intervals.

### Example 4

Oxygen Diffusion into Microchannels. It was found that oxygen diffuses through the device over time scales on the order of ten seconds (roughly ten times faster than occlusion and rescue events which occur over time scales on the order of hundreds seconds). The oxygen concentration within the vascular network was quantified through bonding the microfluidic network to a glass slide coated with a ruthenium complex (FOXY-SGS-M, Ocean Optics, Dunedin, Fla.), which fluoresces under 460 nm excitation and is quenched by oxygen. The intensity of the fluorescence can be correlated to the oxygen concentration through the Stern-Volmer equation. Evans, R. C. and P. Douglas (2006). “Controlling the color space response of colorimetric luminescent oxygen sensors.” Anal Chem 78(16): 5645-52.

It is important to consider the relative rates of ambient deoxygenation and hemoglobin oxygen unloading especially when the collective chemical polymerization and collective hydrodynamics can act in concert. It was expected that the diffusion times for water-filled fluid channels in the control experiment would be similar to those for blood-filled channels because the fluid channel itself is 12 μm (or a few cells) high and represents only 10% of the total diffusion distance which includes a 100 μm thick PDMS membrane between the gas and fluid channels. The velocity profile measurements began with measurable changes in velocity which occur when intracellular oxygen concentration drops below 3% or rises above 1%. Very rapid polymerization occurs when this concentration is below 1-2%. See FIGS. 9-12.

### Example 5

Qualitative Picture of the Events Leading to an in Vitro Vasoocclusive Event. As oxygen concentration in the microchannel falls, either as a function of time due to enhanced demand from the tissues for example or as a function of location away from the lungs, the globular HbS tetramer polymerizes, slowly at first and then explosively. These polymers change both the morphology and stiffness of individual red blood cells, and the concentration of sickled red blood cells increases. This increasing concentration provides greater resistance to flow and eventually leads to vasoocclusion, corresponding with the jamming of blood cells while the plasma may continue to flow along.

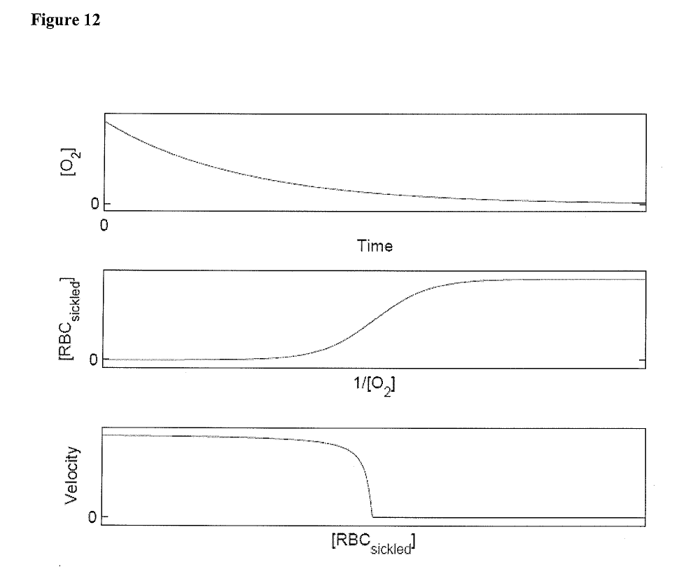

A detailed model requires that one treat the blood as a two-phase fluid consisting of plasma and red blood cells, and prescribe a kinetic relation that characterizes the change in the properties of the red blood cell; i.e., its shape and stiffness as a function of the concentration of fibrous HbS gel inside it. This polymer concentration itself is a function of the ambient oxygen concentration. In FIG. 12, the main events in the process are shown schematically.

### Example 6

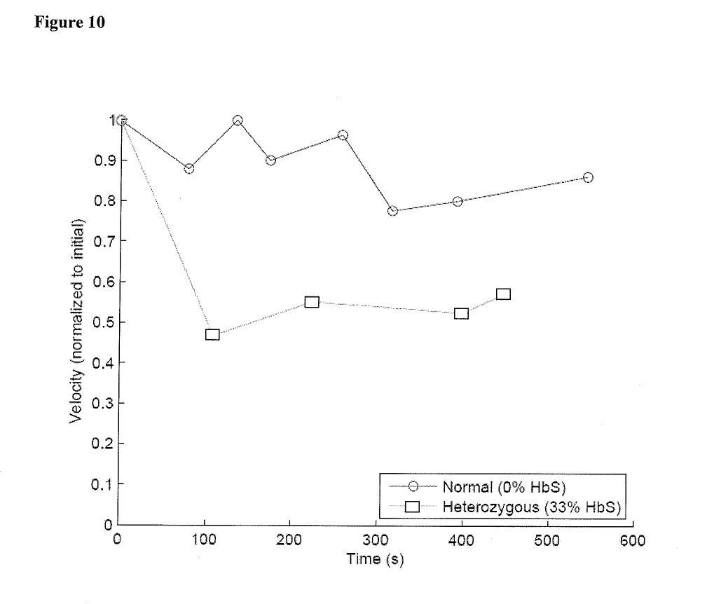

Control Experiments with Wild-Type and Sickle-Trait Blood. To ensure that the observed occlusion was due to the sickling of red blood cells from a patient with the homozygous form of sickle cell disease, experiments with blood from patients with wild-type hemoglobin as well from those heterozygous for the sickle mutation (sickle trait) were conducted. As shown in FIG. 10, there was no occlusion event in either situation, although there was an initial reduction in the velocity of the sickle trait blood.

### Example 7

Pressure Normalization. Pressures shown in the phase space in FIG. 5 were normalized for both hematocrit and the slightly variable resistance of each individual microfluidic device. Pressures were increased or decreased due to the different resistance provided by blood samples with different hematocrits. The hematocrit normalization was calculated according to previously determined relationships between hematocrit and effective viscosity (Lipowsky H H, Usami S, Chien S (1980) Microvasc Res 19:297-319). In practice, this adjustment represented changes of less than 15% relative to the actual pressure.

Pressures were also normalized for the variable resistance provided by each individual microfluidic device. The resistance of each device was assumed to depend on both the specific vascular channel network topology and the number and quality of minor artifacts and defects typically acquired by each device during production. Device resistance was calculated before each occlusion assay as defined by Poiseuille's Law in terms of the known dimension, number, and arrangement of the smallest channels, the applied pressure difference, and the initial flow rate.

Normalized pressure therefore represents an estimate of the pressure that would be needed to generate the flow rate measured if the sample had a hematocrit of 25% and the device had a standard topology without defects as shown in FIG. 2.

### Example 8

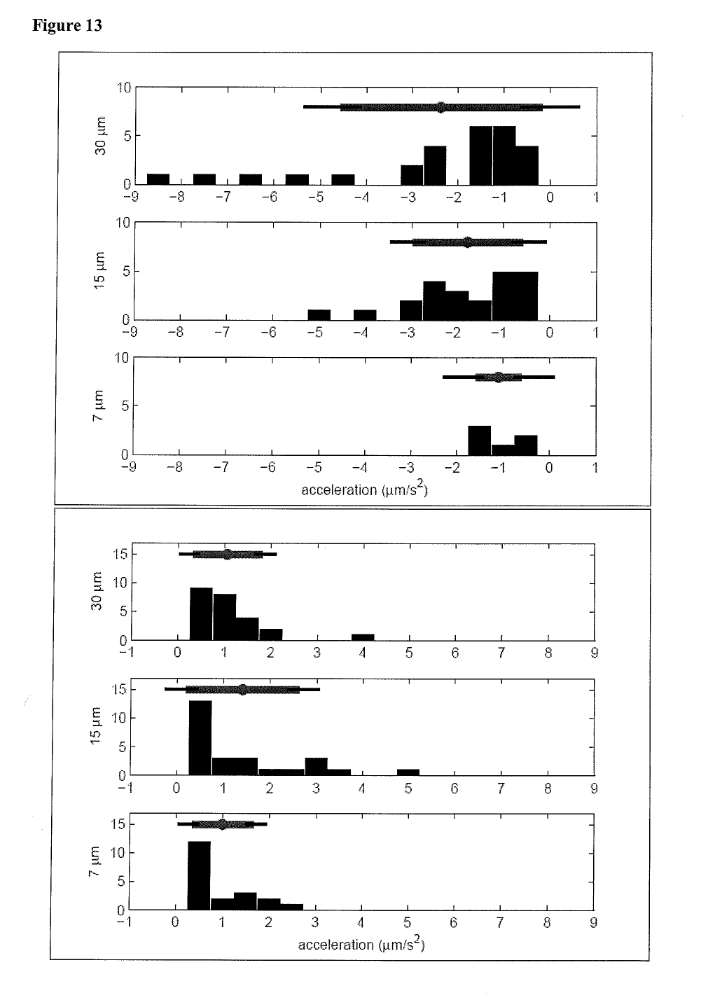

Occlusion and Rescue Hysteresis. The hysteresis in characteristic times to occlusion and rescue was measured, as shown in FIG. 6b. This figure is derived from individual measurements of velocity as a function of time during the onset of occlusion and rescue. Additional information on this relationship between the magnitude of hysteresis and the minimal width of channels in the microfluidic device is shown in FIG. 13. FIG. 13 shows the distributions of instantaneous accelerations during the onset of occlusion and rescue. FIG. 13 Upper suggests that there is greater variability in the rate of acceleration during occlusions in larger width channels than in smaller width channels. In contrast, FIG. 13 Lower suggests that the variability in acceleration during rescue is comparable across the three channel widths shown.

### Example 9

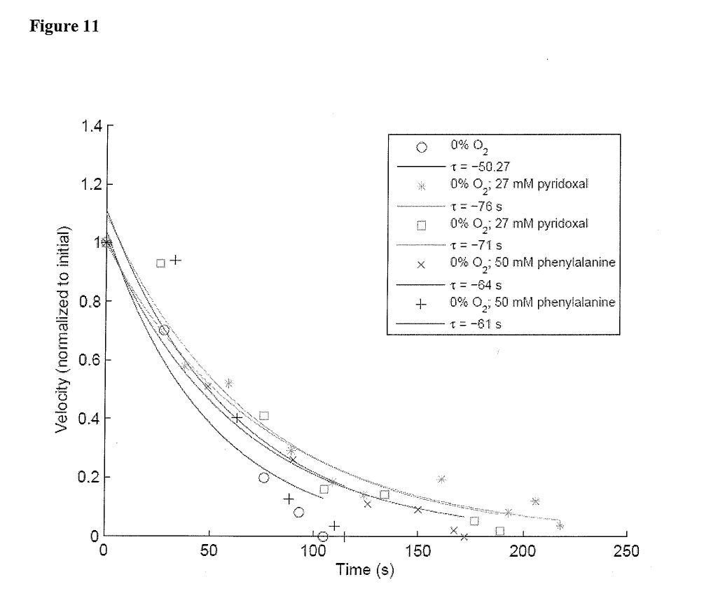

Effect of Phenylalanine and Pyridoxal (a 2,3-Diphosphoglycerate Analog) on Occlusive Events. The impact of two soluble small molecules, phenylalanine and pyridoxal (an analog of 2,3-diphosphoglycerate, or DPG), on the dynamic flow properties of blood in the device, was investigated. Both of these substances are known to slow the rate of HbS polymerization at least modestly by changing the oxygen-HbS binding curve (Chang H, Ewert S M, Bookchin R M, Nagel R L (1983) Blood 61:693-704). However, neither of these two soluble molecules had a significant impact on occlusion velocity profiles (see FIG. 11). These agents cause a modest increase in solubility of deoxygenated HbS: approximately 6% for pyridoxal and 20% for phenylalanine. The experimental conditions likely generated deoxygenated HbS in concentrations greatly in excess of even these increased solubilities.

### Example 10

Data Collection and Analysis. Assays were performed at room temperature. Videos were captured with a PixeLink PL-A781 high-speed video camera (PixeLINK, Ottawa, Ontario). Videos were processed and analyzed using MATLAB, the MATLAB Image Processing Toolbox, and the SIMULINK Video and Image Processing Blockset (The MathWorks, Natick Mass.).

### INCORPORATION BY REFERENCE

All of the U.S. patents and U.S. patent application publications cited herein are hereby incorporated by reference.

### EQUIVALENTS

Those skilled in the art will recognize, or be able to ascertain using no more than routine experimentation, many equivalents to the specific embodiments of the invention described herein. Such equivalents are intended to be encompassed by the following claims.

1. An integrated microfluidic device comprising:
a plurality of interconnected channels comprising a sample inlet and a sample outlet;
a gas reservoir comprising at least one gas inlet and at least one gas outlet; and
a gas-permeable membrane positioned between said plurality of interconnected channels and said gas reservoir;
wherein said plurality of interconnected channels, said gas-permeable membrane and said gas reservoir are positioned to allow gas diffusion from said gas reservoir, through said gas-permeable membrane, into said plurality of interconnected channels; and
the volume of space occupied by the integrated microfluidic device is less than about 80,000 mm³.

2. The integrated microfluidic device of claim 1, wherein the channels in said plurality of interconnected channels intersect; and each intersection is a three way junction.

3. The integrated microfluidic device of claim 2, wherein said channels have substantially similar cross-sectional areas.

4. The integrated microfluidic device of claim 2, wherein said sample inlet leads to a channel of said plurality of interconnected channels which bifurcates two, three, four, five, six, seven, eight, nine, or ten times.

5. The integrated microfluidic device of claim 2, wherein the cross sectional area of said first channel is between about 20,000 μm² and about 60,000 μm².

6. The integrated microfluidic device of claim 2, wherein the cross sectional area of said first channel is about 40,000 μm².

7. The integrated microfluidic device of claim 1, wherein each channel in said plurality of interconnected channels is tube like.

8. The integrated microfluidic device of claim 1, wherein each channel in said plurality of interconnected channels is curved.

9. The integrated microfluidic device of claim 1, wherein the cross-sectional shape of each channel in said plurality of interconnected channels is circular.

10. The integrated microfluidic device of claim 1, wherein said plurality of interconnected channels further comprises a detection region.

11. The integrated microfluidic device of claim 1, wherein the thickness of said gas reservoir is between about 10 μm and about 500 μm.

12. (canceled)

13. The integrated microfluidic device of claim 1, wherein the thickness of said gas reservoir is about 150 μm.

14. The integrated microfluidic device of claim 1, wherein said gas-permeable membrane comprises silicone rubber, polydimethylsiloxane, polytetrafluorethylene, polypropylene, polysulfone, dimethyl siloxane or methylvinyl siloxane.

15. The integrated microfluidic device of claim 1, wherein said gas-permeable membrane is polydimethylsiloxane.

16. The integrated microfluidic device of claim 1, wherein the thickness of said gas-permeable membrane is between about 10 μm and about 500 μm.

17. (canceled)

18. The integrated microfluidic device of claim 1, wherein the thickness of said gas-permeable membrane is about 150 μm.

19. The integrated microfluidic device of claim 1, wherein the gas-permeable membrane is attached to the gas reservoir.

20. (canceled)

21. The integrated microfluidic device of claim 1, wherein the volume of space occupied by the integrated microfluidic device is less than about 20,000 mm³.

22. The integrated microfluidic device of claim 1, wherein the shape of said integrated microfluidic device is a square prism, a rectangular prism, a cylinder, a sphere, a disc, a slide, a chip, a film, a plate, a pad, a tube, a strand, or a box.

23. The integrated microfluidic device of claim 1, wherein said integrated microfluidic device is substantially flat with optional raised, depressed or indented regions to allow ease of manipulation.

24. A method for conducting an analysis, comprising the steps of: introducing a first sample into a sample inlet of an integrated microfluidic device; wherein said integrated microfluidic device comprises a plurality of interconnected channels comprising said sample inlet and a sample outlet; a gas reservoir comprising at least one gas inlet and at least one gas outlet; and a gas-permeable membrane positioned between said plurality of interconnected channels and said gas reservoir; wherein said plurality of interconnected channels, said gas-permeable membrane and said gas reservoir are positioned to allow gas diffusion from said gas reservoir, through said gas-permeable membrane, into said plurality of interconnected channels; and the volume of space occupied by the integrated microfluidic device is less than about 80,000 mm³; and passing said first sample through said plurality of interconnected channels.

25-72. (canceled)
